(19) United States
(12) Patent Application Publication
(10) Pub. No.: US 2020/0244509 A1
(43) Pub. Date: Jul. 30, 2020

(54) IN-PHASE AND QUADRATURE-PHASE ESTIMATION AND CORRECTION USING KERNEL ANALYSIS

(71) Applicant: QUALCOMM Incorporated, San Diego, CA (US)

(72) Inventors: Hao Zhou, San Jose, CA (US); Kapil Rai, Sunnyvale, CA (US); James Gardner, San Ramon, CA (US); Manyuan Shen, San Jose, CA (US); Zhiqun Liu, Foster City, CA (US)

(21) Appl. No.: 16/259,924

(22) Filed: Jan. 28, 2019

(51) Int. Cl. H04L 27/38; H04L 1/00; H04L 27/00

(52) U.S. Cl. CPC H04L 27/3854; H04L 1/0003; H04L 27/0014; H04L 5/0007; H04L 2027/0026; H04L 2027/0075; H04L 2027/0057

(57) ABSTRACT

Methods, systems, and devices for wireless communications are described. A device may receive a signal, such as a wideband or narrowband signal, and determine an in-phase and quadrature-phase imbalance of the signal, a phase and amplitude of the signal, a conjugate of the signal, or any combination thereof. Based on the in-phase and quadrature-phase imbalance, the device may determine a kernel set having a set of in-phase and quadrature-phase imbalance correction terms and select an in-phase and quadrature-phase imbalance correction term from the set based on a selection criteria. The device may then apply the in-phase and quadrature-phase imbalance correction term to the signal.

### BACKGROUND

The following relates generally to wireless communications, and more specifically to in-phase and quadrature-phase estimation and correction using kernel analysis.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include a number of base stations or network access nodes, each supporting communication for multiple communication devices, which may be otherwise known as user equipment (UE). In the wireless multiple-access communications system, a number of the base stations, network access nodes, or communication devices may support in-phase and quadrature-phase signal processing for different reasons. Although in-phase and quadrature-phase signal processing is widely supported, it poses a significant challenge to performance (e.g., efficiency, latency) in these systems.

### SUMMARY

The described techniques relate to improved methods, systems, devices, and apparatuses that support in-phase and quadrature-phase estimation and correction using kernel analysis. A communication device, which may be otherwise known as a user equipment (UE), a base station (e.g., a NodeB or giga-NodeB (either of which may be referred to as a gNB)), and/or other device may support in-phase and quadrature-phase estimation and correction using kernel analysis, and more specifically a nonlinear kernel-based technique. According to the nonlinear kernel-based technique, a communication device may estimate and correct in-phase and quadrature-phase imbalances using a one shot training signal, for example, including orthogonal frequency division multiplexing (OFDM) packets, without any special sequences or a prerequisite for an analog phase shifter, or a wireless local area network (WLAN) packet (e.g., to avoid interruptions and refrain from using special signal assigned for the in-phase and quadrature-phase imbalance correcting).

By estimating and correcting in-phase and quadrature-phase imbalances without any special sequences or a prerequisite for an analog phase shifter, the communication device may conserve processing power (e.g., digital signal processor (DSP) utilization), decrease latency associated with processes related to wireless communication or disruptions in the communication, and improve the hardware footprint utilization of the communication device, among other benefits. In some examples, the training (e.g., transmission of the one shot training signal) may be performed in a mission mode without any interruption. The communication device may additionally, or alternatively perform the training with separate sets of training samples, and reuse digital predistortion (PDP) training blocks, which may provide hardware saving to the communication device. The nonlinear kernel-based technique described herein may also support higher order baseband nonlinearity (e.g., kernels of an order higher than a threshold, such as 5). Although in some examples, the computation of kernel weights for the in-phase and quadrature-phase imbalance estimation may be performed prior to the kernel weights for the in-phase and quadrature-phase imbalance correction, in some examples, the inverse weights or the weights for the in-phase and quadrature-phase imbalance correction may be directly determined from a training signal. That is, a received signal x′(t) and the transmit signal x(t) may both be available. Then the kernels and corresponding weight for the in-phase and quadrature-phase imbalance correction can be directly determined.

A method of wireless communications is described. The method may include receiving a signal, determining an in-phase and quadrature-phase imbalance based on the signal, a phase and amplitude of the signal, a conjugate of the signal, or any combination thereof, determining, based on the in-phase and quadrature-phase imbalance, a kernel set having a set of in-phase and quadrature-phase imbalance correction terms, selecting an in-phase and quadrature-phase imbalance correction term from the set of in-phase and quadrature-phase imbalance correction terms based on a selection criteria, and applying the in-phase and quadrature-phase imbalance correction term to the signal.

An apparatus for wireless communications is described. The apparatus may include a processor, memory in electronic communication with the processor, and instructions stored in the memory. The instructions may be executable by the processor to cause the apparatus to receive a signal, determine an in-phase and quadrature-phase imbalance based on the signal, a phase and amplitude of the signal, a conjugate of the signal, or any combination thereof, determine, based on the in-phase and quadrature-phase imbalance, a kernel set having a set of in-phase and quadrature-phase imbalance correction terms, select an in-phase and quadrature-phase imbalance correction term from the set of in-phase and quadrature-phase imbalance correction terms based on a selection criteria, and apply the in-phase and quadrature-phase imbalance correction term to the signal.

Another apparatus for wireless communications is described. The apparatus may include means for receiving a signal, determining an in-phase and quadrature-phase imbalance based on the signal, a phase and amplitude of the signal, a conjugate of the signal, or any combination thereof, determining, based on the in-phase and quadrature-phase imbalance, a kernel set having a set of in-phase and quadrature-phase imbalance correction terms, selecting an in-phase and quadrature-phase imbalance correction term from the set of in-phase and quadrature-phase imbalance correction terms based on a selection criteria, and applying the in-phase and quadrature-phase imbalance correction term to the signal.

A non-transitory computer-readable medium storing code for wireless communications is described. The code may include instructions executable by a processor to receive a signal, determine an in-phase and quadrature-phase imbalance based on the signal, a phase and amplitude of the signal, a conjugate of the signal, or any combination thereof, determine, based on the in-phase and quadrature-phase imbalance, a kernel set having a set of in-phase and quadrature-phase imbalance correction terms, select an in-phase and quadrature-phase imbalance correction term from the set of in-phase and quadrature-phase imbalance correction terms based on a selection criteria, and apply the in-phase and quadrature-phase imbalance correction term to the signal.

Some examples of the method, apparatuses, and non-transitory computer-readable medium described herein may further include operations, features, means, or instructions for performing a kernel search based on an order of the signal, an order of the conjugate of the signal, or a delay spacing, or a combination thereof, where determining the kernel set having the set of in-phase and quadrature-phase imbalance correction terms may be based on the kernel search.

Some examples of the method, apparatuses, and non-transitory computer-readable medium described herein may further include operations, features, means, or instructions for identifying a loopback configuration related to transmission of the signal, or reception of the signal, or both, where performing the kernel search may be further based on the loopback configuration.

Some examples of the method, apparatuses, and non-transitory computer-readable medium described herein may further include operations, features, means, or instructions for determining a weighting value for the in-phase and quadrature-phase imbalance correction term of the set of in-phase and quadrature-phase imbalance correction terms based on the kernel search, and determining that the weighting value of the in-phase and quadrature-phase imbalance correction term satisfies the selection criteria, where selecting the in-phase and quadrature-phase imbalance correction term from the set of in-phase and quadrature-phase imbalance correction terms may be based on determining that the weighting value of the in-phase and quadrature-phase imbalance correction term satisfies the selection criteria.

Some examples of the method, apparatuses, and non-transitory computer-readable medium described herein may further include operations, features, means, or instructions for applying the weighting value to the in-phase and quadrature-phase imbalance correction term, and including the weighted in-phase and quadrature-phase imbalance correction term in the kernel set, where applying the in-phase and quadrature-phase imbalance correction term to the signal further includes applying the weighted in-phase and quadrature-phase imbalance correction term to the signal.

Some examples of the method, apparatuses, and non-transitory computer-readable medium described herein may further include operations, features, means, or instructions for inverting the weighting value of the in-phase and quadrature-phase imbalance correction term with an in-phase and quadrature-phase imbalance correction structure based on the weighting value satisfying a threshold, applying the inverted weighting value to the in-phase and quadrature-phase imbalance correction term, and including the inverted weighted in-phase and quadrature-phase imbalance correction term in the kernel set, where applying the in-phase and quadrature-phase imbalance correction term to the signal further includes applying the inverted weighted in-phase and quadrature-phase imbalance correction term to the signal.

Some examples of the method, apparatuses, and non-transitory computer-readable medium described herein may further include operations, features, means, or instructions for configuring the in-phase and quadrature-phase imbalance correction structure based on the kernel set, where inverting the weighting value of the in-phase and quadrature-phase imbalance correction term with the in-phase and quadrature-phase imbalance correction structure may be further based on the configuring.

Some examples of the method, apparatuses, and non-transitory computer-readable medium described herein may further include operations, features, means, or instructions for determining a weighting value for a second in-phase and quadrature-phase imbalance correction term of the set of in-phase and quadrature-phase imbalance correction terms based on the kernel search, where the second in-phase and quadrature-phase imbalance correction term may be different from the in-phase and quadrature-phase imbalance correction term, determining that the weighting value of the second in-phase and quadrature-phase imbalance correction term does not satisfy the selection criteria, and discarding the second in-phase and quadrature-phase imbalance correction term from the kernel set, where determining the kernel set may be further based on discarding the second in-phase and quadrature-phase imbalance correction term from the kernel set.

In some examples of the method, apparatuses, and non-transitory computer-readable medium described herein, the weighting value for the in-phase and quadrature-phase imbalance correction term or the second in-phase and quadrature-phase imbalance correction term, or both includes a phase imbalance and amplitude imbalance of the signal.

In some examples of the method, apparatuses, and non-transitory computer-readable medium described herein, the phase imbalance and the amplitude imbalance of the signal may be at least one of a frequency independent in-phase and quadrature-phase imbalance or a frequency dependent in-phase and quadrature-phase imbalance.

Some examples of the method, apparatuses, and non-transitory computer-readable medium described herein may further include operations, features, means, or instructions for determining, based on discarding the second in-phase and quadrature-phase imbalance correction term from the kernel set, that the kernel set having the set of in-phase and quadrature-phase imbalance correction terms may be below a threshold set of in-phase and quadrature-phase imbalance correction terms, determining a weighting value for a third in-phase and quadrature-phase imbalance correction term from the set of in-phase and quadrature-phase imbalance correction terms based on the kernel search, where the third in-phase and quadrature-phase imbalance correction term may be different from the in-phase and quadrature-phase imbalance correction term, determining that the weighting value of the third in-phase and quadrature-phase imbalance correction term satisfies the selection criteria, applying the weighting value to the third in-phase and quadrature-phase imbalance correction term, and including the weighted third in-phase and quadrature-phase imbalance correction term in the kernel set, where the kernel set may be further based on including the weighted third in-phase and quadrature-phase imbalance correction term in the kernel set.

Some examples of the method, apparatuses, and non-transitory computer-readable medium described herein may further include operations, features, means, or instructions for comparing the weighted in-phase and quadrature-phase imbalance correction term in the kernel set to the weighted third in-phase and quadrature-phase imbalance correction term in the kernel set, where selecting the in-phase and quadrature-phase imbalance correction term may be further based on the comparing.

In some examples of the method, apparatuses, and non-transitory computer-readable medium described herein, the set of in-phase and quadrature-phase imbalance correction terms includes higher order terms.

In some examples of the method, apparatuses, and non-transitory computer-readable medium described herein, the kernel set includes a quantity of nonlinear kernels each having a corresponding set of in-phase and quadrature-phase imbalance correction terms.

In some examples of the method, apparatuses, and non-transitory computer-readable medium described herein, the signal includes a wideband signal or a narrowband signal, and the selection criteria includes a normalized mean square error.

### BRIEF DESCRIPTION OF THE DRAWINGS

FIGS. 1 and 2 illustrate examples of a wireless communications system that supports in-phase and quadrature-phase estimation and correction using kernel analysis in accordance with aspects of the present disclosure.

FIGS. 3 through 5 illustrate examples of an in-phase and quadrature-phase structure that supports in-phase and quadrature-phase estimation and correction using kernel analysis in accordance with aspects of the present disclosure.

FIGS. 6 and 7 show block diagrams of devices that support in-phase and quadrature-phase estimation and correction using kernel analysis in accordance with aspects of the present disclosure.

FIG. 8 shows a block diagram of a communications manager that supports in-phase and quadrature-phase estimation and correction using kernel analysis in accordance with aspects of the present disclosure.

FIG. 9 shows a diagram of a system including a device that supports in-phase and quadrature-phase estimation and correction using kernel analysis in accordance with aspects of the present disclosure.

FIGS. 10 through 13 show flowcharts illustrating a method or methods that support in-phase and quadrature-phase estimation and correction using kernel analysis in accordance with aspects of the present disclosure.

### DETAILED DESCRIPTION

A communication device, which may be otherwise known as a user equipment (UE), a base station (e.g., a NodeB, an eNodeB (eNB), a next-generation NodeB or giga-NodeB (either of which may be referred to as a gNB), a Home NodeB, a Home eNodeB, or some other suitable terminology)), or other device in a wireless communications systems, such as fourth generation (4G) systems such as Long Term Evolution (LTE) systems, LTE-Advanced (LTE-A) systems, or LTE-A Pro systems, and fifth generation (5G) systems which may be referred to as New Radio (NR) systems, may support in-phase and quadrature-phase signal processing. In-phase and quadrature-phase signal processing may include various advantages over other techniques, such as higher radio frequency spectrum efficiency (more bits/Hz), lower data converters (e.g., analog-to-digital converters (ADCs), digital-to-analog converters (DACs)) sampling rate for data throughput, reduced computational power, etc.

Although in-phase and quadrature-phase signal processing provides many advantages, any mismatch (also referred to herein as imbalance) of gain or phase between the in-phase and the quadrature-phase of a signal can degrade transceiver performance of the communication device. Examples of contributing factors to mismatch of gain or phase between the in-phase and the quadrature-phase of a signal may include, but is not limited to, radio frequency mixers (e.g., having different gains for the in-phase paths and the quadrature-phase paths), phased-locked loops (e.g., that are responsible to generate quadrature local oscillators produces nonequal in-phase and quadrature-phase signals in terms of phase shift), etc. Therefore, in-phase and quadrature-phase imbalance may pose a challenge on performance (e.g., efficiency, latency) for the communication device.

Some other techniques may use tone-based signals to probe transmit and receive paths of the transceiver of the communication device to estimate the in-phase and quadrature-phase imbalances. Although these other techniques may be generally effective for estimating and correcting in-phase and quadrature-phase imbalances (e.g., frequency independent in-phase and quadrature-phase imbalances and frequency dependent in-phase and quadrature-phase imbalances), these techniques may be an inefficient use of resources (e.g., DSP utilization) of the communication device.

In some examples, depending on frequency selectiveness of the in-phase and quadrature-phase imbalances, either a single tap in-phase and quadrature-phase imbalance correction term for frequency flat in-phase and quadrature-phase imbalances or a multiple tap in-phase and quadrature-phase imbalance correction term for frequency selective in-phase and quadrature-phase imbalances may be generated by inverting the frequency domain in-phase and quadrature-phase imbalance correction term(s) to a time domain filter. In-phase and quadrature-phase imbalances, however, may be fundamentally handled as a nonlinear system, therefore correction of in-phase and quadrature-phase imbalances using linear equalization techniques may be impracticable. To address the shortcomings of standing techniques, the communication device may handle the in-phase and quadrature-phase as a nonlinear inversion problem to support in-phase and quadrature-phase estimation and correction using kernel analysis, and more specifically using nonlinear kernel-based techniques.

As part of the nonlinear kernel-based techniques, the communication device may estimate and correct in-phase and quadrature-phase imbalances using a single signal, for example, including orthogonal frequency division multiplexing (OFDM) packets, without any special training sequences or a prerequisite for an analog phase shifter. For example, a communication device may receive a signal, such as a wideband signal or a narrowband signal, and determine an in-phase and quadrature-phase imbalance based on the signal, a phase and amplitude of the signal, a conjugate of the signal, or any combination thereof. The communication device may then determine, based on the in-phase and quadrature-phase imbalance, a kernel set having a set of in-phase and quadrature-phase imbalance correction terms, and select an in-phase and quadrature-phase imbalance correction term from the set based on a selection criteria (e.g., normalized mean square error (MSE)).

To resolve the in-phase and quadrature-phase imbalance, the communication device may apply the in-phase and quadrature-phase imbalance correction term to the signal. In some examples, there may be more than one in-phase and quadrature-phase imbalance correction term from the set that satisfies a selection criteria. For example, the communication device may evaluate and determine that the weights of all in-phase and quadrature-phase imbalance correction terms from the set together satisfy the selection criteria, which may be based on the normalized MSE for example, or could be the weight power itself. Additionally, in some examples, kernel-identification may be performed for a particular SKU once. Thereafter, kernel weight training may be done for every calibration. As such, the entire process of kernel search and kernel weight determination may be performed on any communication device, if programmable kernel implementation is feasible on the communication device. By estimating and correcting in-phase and quadrature-phase imbalances using kernel analysis, the communication device may conserve processing power (e.g., digital signal processor (DSP) utilization), decrease latency associated with processes related to wireless communication, or disruptions in the communication, and improve the hardware footprint utilization of the communication device.

Aspects of the disclosure are initially described in the context of a wireless communications system. Aspects of the disclosure are then described in the context of an in-phase and quadrature-phase structure. Aspects of the disclosure are further illustrated by and described with reference to apparatus diagrams, system diagrams, and flowcharts that relate to in-phase and quadrature-phase estimation and correction using kernel analysis.

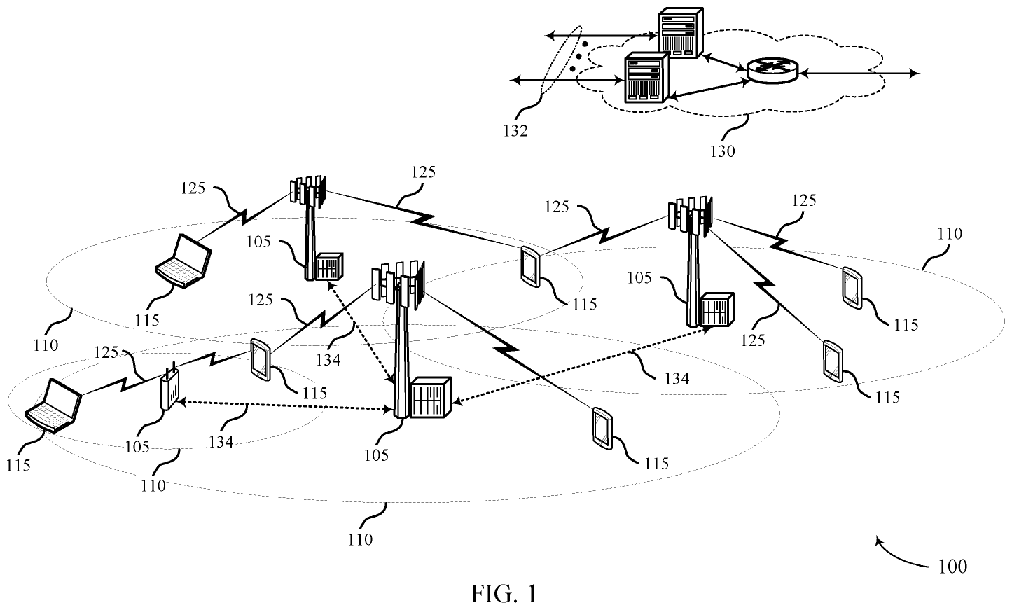

FIG. 1 illustrates an example of a wireless communications system 100 that supports in-phase and quadrature-phase estimation and correction using kernel analysis in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some examples, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

In some examples, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some examples, groups of UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130). The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

In some examples, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some examples, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. In one example, a base station 105 may use multiple antennas or antenna arrays to conduct beamforming operations for directional communications with a UE 115. For instance, some signals (e.g. synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105. In some examples, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some examples, the wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

In some examples, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some examples, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type). The wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some examples, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some examples, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some examples, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some examples, the TTI duration (that is, the number of symbol periods in a TTI) may be variable. The wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

Base stations 105 and UEs 115 may in some examples experience imbalance between an in-phase and a quadrature-phase of a signal. The in-phase and quadrature-phase imbalance may reduce transceiver performance of base stations 105 and UEs 115. To address the in-phase and quadrature-phase imbalance, one or more devices may perform in-phase and quadrature-phase estimation and correction using kernel analysis, and more specifically nonlinear kernel-based techniques in some cases. Kernel-based techniques have been in some examples deployed in nonlinear power amplifier analysis. For a power amplifier having an input x and an output y, a kernel vector for nonlinear power amplifier analysis may be defined as K(y), which may follow a certain form of nonlinearity and memory delay construction. The kernel-based nonlinear power amplifier analysis for kernel-based digital predistortion may be defined by the following expression:

K(y)w=x (1)

where K(y) is the kernel matrix, x is the target vector (e.g., the power amplifier input), and w is the kernel weight vector. In some examples, the kernel matrix K(y) may include a set of kernel vectors (e.g., K(y)=[K₁(y) . . . Kᵢ(y)], where Kᵢ(y) is the i-th kernel vector). Alternatively, a kernel-based power amplifier model may be defined by the following expression:

K(x)w=y (2)

where K(x) is the kernel matrix, y is the target vector (e.g., the power amplifier output), and w is the kernel weight vector. Kernel-based analysis has shown to be effective for nonlinear memory power amplifiers by determining its kernel set and computing its corresponding weight vector. Accordingly, base stations 105 and UEs 115 may address the in-phase and quadrature-phase imbalance using similar kernel analysis.

For example, base stations 105 and UEs 115 may receive a signal x, such as a wideband signal or a narrowband signal, and determine an in-phase and quadrature-phase imbalance based on the signal x, a phase and amplitude of the signal x, a conjugate of the signal x, or any combination thereof. Base stations 105 and UEs 115 may then determine, based on the in-phase and quadrature-phase imbalance, a kernel set having a set of in-phase and quadrature-phase imbalance correction terms, and select an in-phase and quadrature-phase imbalance correction term from the set based on a selection criteria (e.g., normalized mean square error (MSE)). For example, the kernel analysis for estimating the in-phase and quadrature-phase imbalance may be defined by the following expression:

K(x)w=y (3)

where K(x) is the kernel matrix, y is the output, and w is the kernel weight vector. In some examples, input to the kernel of the in-phase and quadrature-phase may be defined by format of x and x* (i.e., the original signal, the conjugate of the signal, and the combined memory delays). Alternatively, the kernel analysis for correcting the in-phase and quadrature-phase imbalance may be defined by the following expression:

K(y)w=x (3)

where K(y) is the kernel matrix, x is the input, and w is the kernel weight vector. In some examples, the kernel matrix K(y) may include a set of kernel vectors (e.g., K(y)=[K₁(y) . . . Kᵢ(y)], where Kᵢ(y) is the i-th kernel vector). To resolve the in-phase and quadrature-phase imbalance, base stations 105 and UEs 115 may apply the in-phase and quadrature-phase imbalance correction term (e.g., kernel weight vector) to the signal x. By estimating and correcting in-phase and quadrature-phase imbalances using kernel analysis, base stations 105 and UEs 115 may conserve processing power (e.g., digital signal processor (DSP) utilization), decrease latency associated with processes related to wireless communication, or disruptions in the communication, and improve the hardware footprint utilization of base stations 105 and UEs 115. In addition, the techniques described herein may provide improvement in the performance of a transceiver of base stations 105 and UEs 115, in presence of frequency dependent in-phase and quadrature-phase imbalance. As a result, this may allow higher order modulations (e.g., high QAM) to be supported allowing very high data rates and throughput by the base stations 105 and the UEs 115.

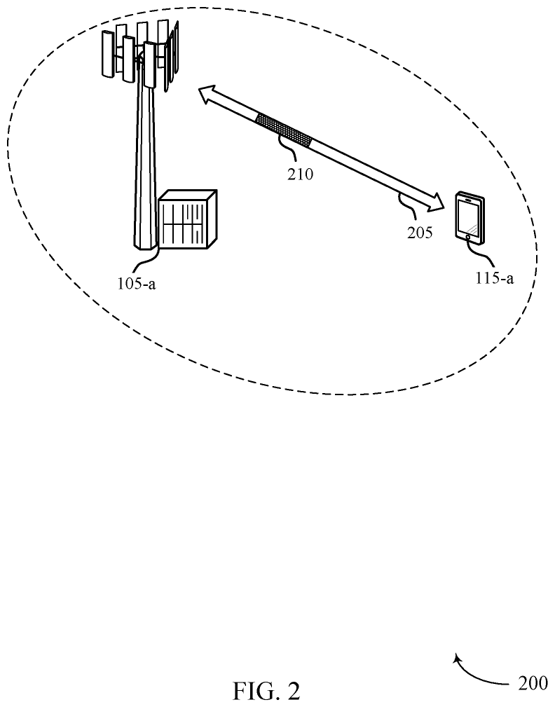

FIG. 2 illustrates an example of a wireless communications system 200 that supports in-phase and quadrature-phase estimation and correction using kernel analysis in accordance with aspects of the present disclosure. The wireless communications system 200 may include a base station 105-a and a UE 115-a, which may be examples of the corresponding devices described with reference to FIG. 1. The wireless communications system 200 may also implement aspects of the wireless communications system 100, such as the base station 105-a and/or the UE 115-a supporting in-phase and quadrature-phase estimation and correction using kernel analysis, and more specifically a nonlinear kernel-based technique.

The base station 105-a and the UE 115-a may establish a bi-directional communication link 205 for downlink and uplink communications. For example, the base station 105-a may perform a communication procedure (e.g., a radio resource control procedure, such as a cell acquisition procedure, random access procedure, radio resource control connection procedure, radio resource control configuration procedure) with the UE 115-a to establish the bi-directional communication link 205. Some examples of downlink or uplink communications may include communication of signal 210. For example, the base station 105-a may transmit signal 210 in downlink communications to the UE 115-a. Alternatively, the UE 115-a may transmit another signal 210 in uplink communications to the base station 105-a.

The signal 210 may be, in some examples, a baseband signal, a narrowband signal, a wideband signal, etc. Signal 210 may also be represented as a variation in time t and may be denoted as x(t). In some examples of the wireless communications system 200, the base station 105-a and UE 115-a may support bandpass transmission including transmitting the signal 210 in an allocated radio frequency spectrum, so translating the signal 210 to a carrier frequency and vice-versa may be a significant process of a transceiver of the base station 105-a and UE 115-a. The baseband signal (e.g., signal 210) may be defined as a complex-valued signal z(t)=x(t)+x(t)*, where x(t) may be the in-phase component and x(t)* may be the in-quadrature component (e.g., conjugate of x(t)). In some examples, the base stations 105-a and the UE 115-a may experience imbalance between the in-phase and the quadrature-phase of the signal 210.

In some examples, the signal 210 may be an OFDM baseband signal communicated on multiple carriers (e.g., simultaneously) with each of the carrier frequencies orthogonal to each other. Imbalance between the in-phase and the quadrature-phase for an OFDM baseband signal may cause subcarriers to create an image on a symmetric subcarrier (e.g., subcarrier k creating an image on subcarrier −k). This effect resembles inter-carrier interference as the subcarrier at k leaks into the subcarrier at −k and vice-versa. As a result, inter-carrier interference may effect frequency dependent and frequency independent in-phase and quadrature-phase imbalances. To resolve the in-phase and quadrature-phase imbalance, the base station 105-a and/or the UE 115-a may estimate and correct the imbalance using kernel analysis.

In some examples, the base station 105-a and/or the UE 115-a may model the baseband signal in-phase and quadrature-phase imbalance according to the following expression:

z(t)=x(t)+IQ(t)x(t)* (4)

In some examples, in-phase and quadrature-phase imbalance may be at least one of a frequency independent in-phase and quadrature-phase imbalance or a frequency dependent in-phase and quadrature-phase imbalance. In an example of frequency independent in-phase and quadrature-phase imbalance, the IQ(t) may be a simple impulse response. For an in-phase and quadrature-phase imbalance below a threshold, the frequency independent in-phase and quadrature-phase imbalance may be modeled according to the following expression:

IQ(t)=(ε+jθ)×δ(t) (5)

where ε is the amplitude imbalance and θ is the phase imbalance. In some examples, when modeled in discrete digital wireless communications systems, the expression (5) may be defined according to the following expression:

z=x+(ε+jθ)×x* (6)

For frequency dependent in-phase and quadrature-phase imbalances (e.g., for wideband wireless communications systems), the in-phase and quadrature-phase imbalances may have certain time-domain dispersion, which may translate to non-flat frequency domain response for the in-phase and quadrature-phase image of the signal 210. To resolve such frequency dependent in-phase and quadrature-phase imbalances, some other techniques may estimate the in-phase and quadrature-phase imbalance of a channel at several frequency spots via tone probing (e.g., single tone or multi-tones) and determine the negative of the obtained frequency domain in-phase and quadrature-phase imbalance estimate and translate that into time domain response. The time domain response can then be implemented via a complex valued finite-impulse response (FIR) filter in digital design. Although such techniques may resolve the in-phase and quadrature-phase imbalance at least partially, it may use an unnecessary amount of resources (e.g., hardware), among others.

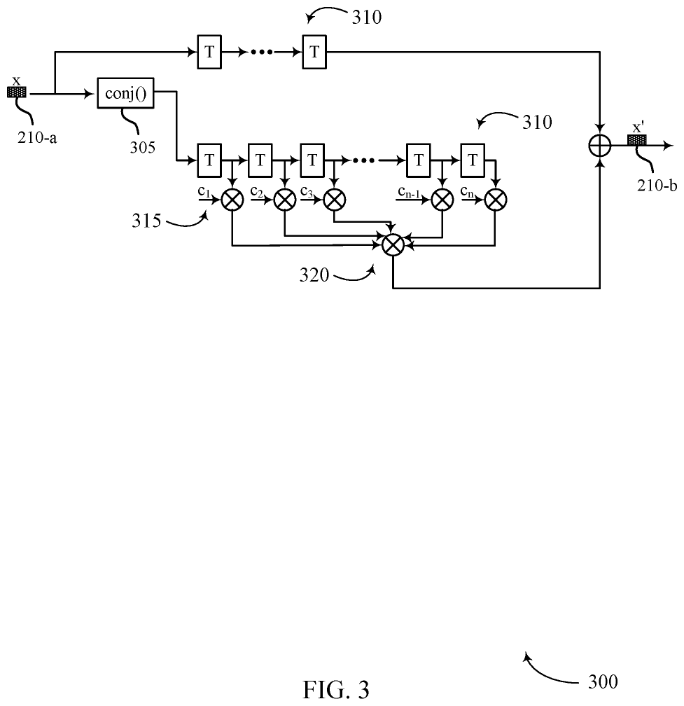

By way of example for estimating and correcting frequency independent or frequency dependent in-phase and quadrature-phase imbalances, the base station 105-a and/or the UE 115-a may determine and select a kernel set having a set of in-phase and quadrature-phase imbalance correction terms, and determine a weighting value for each correction term. If the weighted correction terms satisfy a threshold, the base station 105-a and/or the UE 115-a may identify or determine that those terms are associated with the distortion of the signal 210 due to the wireless communications system 200, and invert the weighted correction terms according to an in-phase and quadrature-phase imbalance correction structure (as shown in FIGS. 2 and 3). Otherwise, if the weighted correction terms do not satisfy the threshold, the base station 105-a and/or the UE 115-a may discard the corresponding weighted correction terms or the entire kernel set because the weighted correction terms may not contribute to the distortion of the signal 210.

For example, the base station 105-a and/or the UE 115-a may determine an in-phase and quadrature-phase imbalance based on the signal 210, a phase and amplitude of the signal 210, a conjugate of the signal 210, or any combination thereof. The base station 105-a and/or the UE 115-a may determine or select, based on the in-phase and quadrature-phase imbalance, a kernel set having a set of in-phase and quadrature-phase imbalance correction terms. In some examples, linear, weak nonlinear and strong nonlinear variation of in-phase and quadrature-phase imbalance(s) across frequency band(s) may be possible.

A kernel set, for example, may be defined as [bMode, m-delay, g-delay, amplitude order, full order]. The bMode may have a value of “0” or “11,” where “0” refers to the signal 210 and “11” refers to the conjugate of the signal 210. The m-delay, g-delay, amplitude order may be defined by the following expression |b|^{k}b or |b|^{k}b*. The order of the kernel set may be defined by the following expression k+1. In some examples, the set of in-phase and quadrature-phase imbalance correction terms may include higher order terms. To determine the kernel set, the base station 105-a and/or the UE 115-a may, in some examples, perform a kernel search, which may be based on an order of the signal 210, an order of the conjugate of the signal 210, a delay spacing, or the like, or a combination thereof. In some examples, the kernel set may include a quantity of nonlinear kernels each having a corresponding set of in-phase and quadrature-phase imbalance correction terms.

Some examples of wireless communications system 200 may include both transmit in-phase and quadrature-phase imbalances and receive in-phase and quadrature-phase imbalances. The base station 105-a and/or the UE 115-a may identify a loopback configuration related to transmission of the signal 210, or reception of the signal 210, or both to address the both the transmit and receive in-phase and quadrature-phase imbalances. The kernel search may be based at least in part on the loopback configuration.

The in-phase and quadrature-phase imbalances estimation may commence with transmitting signal 210 with only one rail (either the in-phase or the quadrature-phase), such that there would be no transmit in-phase and quadrature-phase imbalances in the loopback. Therefore, the loopback capture can be used for the receive in-phase and quadrature-phase imbalance analysis. Once the receive in-phase and quadrature-phase is estimated and corrected, the base station 105-a and the UE 115-b may turn back on the transmit in-phase and quadrature-phase full rails to analyze the transmit in-phase and quadrature-phase imbalance. The kernel-based analysis may resolve the in-phase and quadrature-phase imbalance without additional analog phase shift circuits, such as required in other techniques.

As part of the kernel search, the base station 105-a and/or the UE 115-a may determine a weighting value (e.g., a kernel weight vector) for at least some of if not each of the in-phase and quadrature-phase imbalance correction terms. The base station 105-a and/or the UE 115-a, for example, may determine that a weighting value for an in-phase and quadrature-phase imbalance correction term satisfies a selection criteria, such as a normalized MSE. The weighting value may be a phase imbalance and an amplitude imbalance of the signal 210. The phase imbalance and the amplitude imbalance of the signal 210 can be at least one of a frequency independent or frequency dependent in-phase and quadrature-phase imbalance. In some examples, the base station 105-a and/or the UE 115-a may invert the weighting value of the in-phase and quadrature-phase imbalance correction term with an in-phase and quadrature-phase imbalance correction structure based on the weighting value satisfying a threshold. The base station 105-a and/or the UE 115-a may apply the inverted weighting value to the in-phase and quadrature-phase imbalance correction term, and include the inverted weighted in-phase and quadrature-phase imbalance correction term in the kernel set.

Alternatively, the base station 105-a and/or the UE 115-a may determine whether multiple in-phase and quadrature-phase imbalance correction terms satisfy or do not satisfy a selection criteria. In this example, the base station 105-a and/or the UE 115-a may apply corresponding weighting values to the in-phase and quadrature-phase imbalance correction terms, and include the weighted in-phase and quadrature-phase imbalance correction term in the kernel set. For example, the base station 105-a and/or the UE 115-a may determine a weighting value for a second in-phase and quadrature-phase imbalance correction term of the set of in-phase and quadrature-phase imbalance correction terms based on the kernel search, and determine that the weighting value of the second in-phase and quadrature-phase imbalance correction term does not satisfy the selection criteria. In this example, the base station 105-a and/or the UE 115-a may discard the second in-phase and quadrature-phase imbalance correction term from the kernel set, because the second in-phase and quadrature-phase imbalance correction term does not contribute to the distortion of the signal 210. Discarding, for example, the second in-phase and quadrature-phase imbalance correction term may be part of an iterative process. That is, there can be multiple in-phase and quadrature-phase imbalance correction terms found that satisfy the selection criterion, and the search may randomly identify a good term that is kept and a bad term that is to be discarded.

In some examples, the base station 105-a and/or the UE 115-a may continue to perform the kernel search until a threshold number of in-phase and quadrature-phase imbalance correction terms have been determined. For example, the base station 105-a and/or the UE 115-a may determine, based on discarding the second in-phase and quadrature-phase imbalance correction term from the kernel set, that the kernel set having the set of in-phase and quadrature-phase imbalance correction terms is below a threshold set of in-phase and quadrature-phase imbalance correction terms.

As a result, the base station 105-a and/or the UE 115-a may determine a weighting value for a third in-phase and quadrature-phase imbalance correction term from the set of in-phase and quadrature-phase imbalance correction terms, and determine that the weighting value of the third in-phase and quadrature-phase imbalance correction term satisfies the selection criteria. The base station 105-a and/or the UE 115-a may apply the weighting value to the third in-phase and quadrature-phase imbalance correction term and include the weighted third in-phase and quadrature-phase imbalance correction term in the kernel set. Upon satisfying the threshold number of in-phase and quadrature-phase imbalance correction terms for the kernel set, the base station 105-a and/or the UE 115-a may compare the weighted in-phase and quadrature-phase imbalance correction terms in the kernel set to select an in-phase and quadrature-phase imbalance correction term to apply to the signal 210. The base station 105-a and/or the UE 115-a may use the selected in-phase and quadrature-phase imbalance correction term to apply it to the signal 210 to resolve the in-phase and quadrature-phase imbalance.

Table 1 below shows an example of a kernel-based analysis results for a frequency independent in-phase and quadrature-phase imbalance system related to a transmit path of the signal 210. The kernel sets and weighting values in Table 1 may be based at least in part on the following example parameters, among others: a phase imbalance of the signal 210 (e.g., θ is 20°), an amplitude imbalance of the signal 210 (e.g., −10 decibels (dB) (−10%)), and a signal-to-noise ratio (SNR) value (e.g., 50 dB).

The kernel sets and weighting values in Table 1 may be based on a modeling the signal 210 according to the following expression x+(−0.1000−0.3491i)×x*). The kernel search for the obtaining the kernel sets and weighting values in Table 1 may be based on a first order of x and x* with a certain delay spacing of (e.g., −4:1:4). In some examples, the signal 210 may have the following properties to obtain the kernel sets and weighting values in Table 1, for example, the signal 210 may be an 11AC 80M signal at 800 MHz sampling. As shown in Table 1, the threshold number (e.g., target) of kernel sets is set to 5. Table 1 also compares the kernel-based analysis to other techniques.

TABLE 1
Frequency Independent IQ Imbalance system

| | TX IQ imbalance analysis results | | TX IQ correction results | |
|---|---|---|---|---|
| | Kernel Set | P (weights) | Kernel Set | P (weights) |
| Analysis | 0 0 0 0 1 | 1.0000 + 0.0000i | 0 0 0 0 1 | 0.6366 + 0.0006i |
| Results | 11 0 0 0 1 | −0.1000 − 0.3491i | 11 0 0 0 1 | 0.1152 + 0.4021i |
| | 0 1 0 0 1 | −0.0000 − 0.0000i | 0 −1 0 0 1 | 0.1987 − 0.0003i |
| | 11 −4 0 0 1 | −0.0000 − 0.0000i | 0 1 0 0 1 | 0.3829 − 0.0004i |
| | 11 4 0 0 1 | −0.0000 − 0.0000i | 0 3 0 0 1 | −0.0661 + 0.0000i |
| NMSE(dB) | | −50.00 | | −49.4 |

| | TX IQ correction results | | |
|---|---|---|---|
| | (Limit on 1 tap only direct signal × path) | | Other tone based TX IQ correction results |
| | Kernel Set | P (weights) | h |
| Analysis | 0 0 0 0 1 | 1.1519 + 0.0000i | 0.3490 − 0.10001 |
| Results | 11 0 0 0 1 | 0.1152 + 0.4021i | |
| NMSE(dB) | | −49.99 | −49.99 |

Table 2 below shows an example of a kernel-based analysis results for a frequency dependent large in-phase and quadrature-phase imbalance system related to a transmit path of the signal 210. The kernel sets and weighting values in Table 2 may be based at least in part on the following example parameters, among others: a phase imbalance of the signal 210 (e.g., θ is 20°), an amplitude imbalance of the signal 210 (e.g., −10 dBs), an SNR value (e.g., 50 dB), and loopback SNR value (e.g., 30 dBs). The kernel sets and weighting values in Table 2 may be based on a modeling the signal 210 according to the following expression xₙ+(−0.1000−0.3491i)×xₙ₋₁*). The kernel search for the obtaining the kernel sets and weighting values in Table 2 may be based on a first order of x and x* with a certain delay spacing of (e.g., −4:1:4). In some examples, the signal 210 may have the following properties to obtain the kernel sets and weighting values in Table 2, for example, the signal 210 may be an 11AC 80M signal at 800 MHz sampling. As shown in Table 2, the threshold number (e.g., target) of kernel sets is set to 5. Table 2 also compares the kernel-based analysis to other techniques. In some examples, Table 2 below shows frequency dependent large in-phase and quadrature-phase imbalance system for a transceiver (transmit path of the signal 210) in-phase and quadrature-phase correction. By way of example, kernel set [0 1 0 0 1] with [0.5723+0.0001i] kernel weights and/or kernel set [0 −1 0 0 1] with [0.5808−0.001i] kernel weights in Table 2 may support in-phase and quadrature-phase imbalance in the direct path. This may lead to a normalized MSE(dB) of −51.86 dB in contrast to the other schemes of −38.37 dB or when direct signal path is limited to 1-tap only.

TABLE 2
Frequency Dependent Large IQ Imbalance system

| | TX IQ imbalance analysis results | | TX IQ correction results | |
|---|---|---|---|---|
| | Kernel Set | P (weights) | Kernel Set | P (weights) |
| Analysis | 0 1 0 0 1 | 0.9998 − 0.0001i | 11 −1 0 0 1 | 0.0451 + 0.1596i |
| Results | 11 0 0 0 1 | −0.1000 − 0.3489i | 11 −2 0 0 1 | 0.0469 + 0.1623i |
| | 11 2 0 0 1 | 0.0000 − 0.0002i | 0 1 0 0 1 | 0.5723 + 0.0001i |
| | 0 4 0 0 1 | 0.0002 + 0.0002i | 0 −1 0 0 1 | 0.5808 − 0.0001i |
| | 0 −4 0 0 1 | 0.0002 + 0.0000i | 11 1 0 0 1 | 0.0235 + 0.0815i |
| NMSE(dB) | | −30.00 | | −51.86 |

| | TX IQ correction results | | | |
|---|---|---|---|---|
| | (Limit on 1 tap only direct signal × path) | | Other tone based TX IQ correction results | |
| | Kernel Set | P (weights) | Ideal (h) | h |
| Analysis | 0 0 0 0 1 | 1.1343 − 0.0001i | 0.0000 + 0.0000i | −0.0510 + 0.0142i |
| Results | 11 −1 0 0 1 | 0.0439 + 0.1495i | 0.1000 + 0.3491i | 0.0216 − 0.0061i |
| | 11 −2 0 0 1 | 0.0495 + 0.1730i | | 0.0735 − 0.0207i |
| | 11 2 0 0 1 | 0.0247 + 0.0891i | | 0.1008 − 0.0285i |
| | 11 0 0 0 1 | −0.0056 − 0.0195i | | 0.1015 − 0.0289i |
| | | | | 0.0760 − 0.0219i |
| | | | | 0.0266 − 0.0083i |
| NMSE(dB) | | −38.6 | −38.5 | −38.37 |

Table 3 below shows an example of a kernel-based analysis results for a frequency dependent medium in-phase and quadrature-phase imbalance system related to a transmit path of the signal 210. The kernel sets and weighting values in Table 3 may be based at least in part on the following example parameters, among others: a phase imbalance of the signal 210 (e.g., θ is −8°), an amplitude imbalance of the signal 210 (e.g., −4 dBs), an SNR value (e.g., 50 dB), and loopback SNR value (e.g., 30 dBs). The kernel sets and weighting values in Table 2 may be based on a modeling the signal 210 according to the following expression xₙ+(−0.0400−0.1396i)×xₙ₋₁*). The kernel search for the obtaining the kernel sets and weighting values in Table 2 may be based on a first order of x and x* with a certain delay spacing of (e.g., −4:1:4). In some examples, the signal 210 may have the following properties to obtain the kernel sets and weighting values in Table 3, for example, the signal 210 may be an 11AC 80M signal at 800 MHz sampling. As shown in Table 3, the threshold number (e.g., target) of kernel sets is set to 5. Table 3 also compares the kernel-based analysis to other techniques.

TABLE 3
Frequency Dependent Medium IQ Imbalance system

| | TX IQ imbalance analysis results | | TX IQ correction results | |
|---|---|---|---|---|
| | Kernel Set | P | Kernel Set | P |
| Analysis | 0 1 0 0 1 | 1.0000 + 0.0001i | 0 0 0 0 1 | 0.3931 + 0.0004i |
| Results | 11 0 0 0 1 | −0.0400 − 0.1394i | 11 −1 0 0 1 | 0.0406 + 0.1422i |
| | 0 4 0 0 1 | −0.0000 − 0.0002i | 0 −1 0 0 1 | 0.3066 − 0.0004i |
| | 11 −4 0 0 1 | 0.0001 + 0.0008i | 0 1 0 0 1 | 0.3599 + 0.0002i |
| | 11 −3 0 0 1 | −0.0001 − 0.0010i | 0 3 0 0 1 | −0.0342 − 0.0002i |
| NMSE(dB) | | −30.00 | | −47.54 |

| | TX IQ correction results | | | |
|---|---|---|---|---|
| | (Limit on 1 tap only direct signal × path) | | Other tone based TX IQ correction results | |
| | Kernel Set | P | Ideal (h) | h |
| Analysis | 0 0 0 0 1 | 1.0190 − 0.0000i | 0.0000 + 0.0000i | −0.0208 + 0.0060i |
| Results | 11 −1 0 0 1 | 0.0161 + 0.0553i | 0.0400 + 0.1396i | 0.0086 − 0.0024i |
| | 11 0 0 0 1 | 0.0161 + 0.0530i | | 0.0297 − 0.0085i |
| | 11 −2 0 0 1 | 0.0101 + 0.0381i | | 0.0407 − 0.0116i |
| | 11 2 0 0 1 | −0.0015 − 0.0037i | | 0.0409 − 0.0117i |
| | | | | 0.0304 − 0.0087i |
| | | | | 0.0102 − 0.0030i |
| NMSE(dB) | | −42.6 | −42.6 | −42.6 |

As shown in Tables 1 through 3, according to of frequency independent in-phase and quadrature-phase imbalance estimation and correction, the kernel-based analysis can estimate the in-phase and quadrature-phase imbalance based on an arbitrary signal, as well as the other techniques estimates based on tone probing. In particular, the kernel-based analysis provides greater performance improvements for in-phase and quadrature-phase imbalance estimation and correction compared to other techniques. Another observation from Tables 1 through 3 is that when generating the in-phase and quadrature-phase correction using kernel-based analysis, limiting the number of kernels in the kernel set may grant a better quality (e.g., limiting kernel set to 2 kernels grants the best quality) in some cases. That is, limiting the number of kernels in the kernel set may grant a better quality (e.g., limiting kernel set to 2 kernels grants the best quality like in the case of frequency independent imbalance) in some cases.

Accordingly, the techniques described herein may provide improvements in in-phase and quadrature-phase estimation and correction. For example, the techniques described herein objective is to minimize error of the signal 210, rather than simply cancel the in-phase and quadrature-phase mismatch. Additionally, whereas standing techniques rely on transmitting a special signal (e.g., a single tone) to calibrate in-phase and quadrature-phase mismatch, the techniques described herein does not require the use of a specialized signal. Furthermore, the techniques described herein may provide benefits and enhancements to the operation of the UE 115-a. For example, by estimating and correcting in-phase and quadrature-phase imbalances using kernel analysis, the operational characteristics, such as power consumption, processor utilization, and memory usage of the UE 115-a may be reduced. The techniques described herein may also provide efficiency to the UE 115-a by reducing latency associated with processes related to estimating and correcting in-phase and quadrature-phase imbalances. In addition, the techniques described herein may provide improvement in the performance of the transceiver of the UE 115-a, in presence of frequency dependent in-phase and quadrature-phase imbalance. As a result, this may allow higher order modulations (e.g., high QAM) to be supported allowing very high data rates and throughput by the UE 115-a.

FIG. 3 illustrates an example of an in-phase and quadrature-phase structure 300 that supports in-phase and quadrature-phase estimation and correction using kernel analysis in accordance with aspects of the present disclosure. The in-phase and quadrature-phase structure 300 may also be referred to as in-phase and quadrature-phase imbalance correction structure 300. In some examples, the in-phase and quadrature-phase structure 300 may implement aspects of the wireless communications systems 100 and 200, including one or more devices of these systems. For example, in-phase and quadrature-phase structure 300 may be or include an FIR filter that supports correcting in-phase and quadrature-phase imbalances. The in-phase and quadrature-phase structure 300 may receive as input a signal 210-a, which may be an example of aspects of a signal as described herein. The signal 210-a, for example, may be a complex signal. As such, both rails in the in-phase and quadrature-phase structure 300 may process a complex signal (e.g., x), where a first rail process the complex signal and a second rail processes the conjugate 305 of the complex signal (e.g., x*).

The input signal 210-a may be passed through a first rail that may output a real-valued component of the signal 210-a, and may be passed through a second rail that may output a complex-valued component of the signal 210-a. In some examples, the first rail and the second rail may include a set of tone probing elements 310 to estimate in-phase and quadrature-phase imbalance of a channel at several frequency spots. As part of the second rail, the in-phase and quadrature-phase structure 300 may include a set of components that may store or be configured to act as weighted coefficients 315 (also referred to herein as weighting values).

For example, each tone probing element 310 may at a certain frequency spot probe the signal 210-a (e.g., conjugate of the signal 210-a). In addition, the in-phase and quadrature-phase structure 300 may apply to each output of the tone probing element 310 (e.g., probed signal 210-a) a weighted coefficient 315. The in-phase and quadrature-phase structure 300 may, using one or more components, then sum the set of weighted probed signal 210-a. As a result, the in-phase and quadrature-phase structure 300 may output a signal 210-b, which may be a sum of a real-valued component of the signal 210-a and a complex-valued component of the signal 210-a. That is, the signal 210-b is corrected for the in-phase and quadrature-phase imbalance of the signal 210-a.

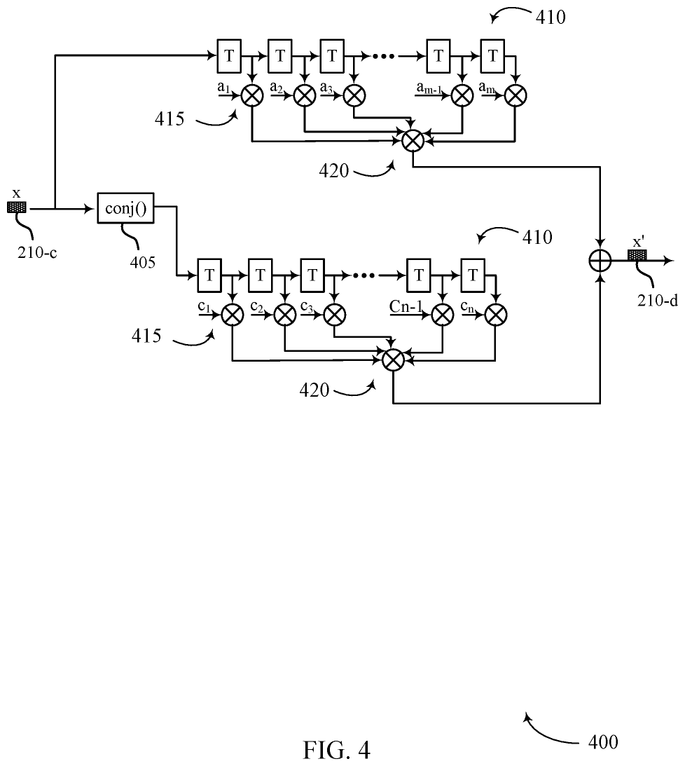

FIG. 4 illustrates an example of an in-phase and quadrature-phase structure 400 that supports in-phase and quadrature-phase estimation and correction using kernel analysis in accordance with aspects of the present disclosure. The in-phase and quadrature-phase structure 400 may also be referred to as in-phase and quadrature-phase imbalance correction structure 400. In some examples, the in-phase and quadrature-phase structure 400 may implement aspects of the wireless communications systems 100 and 200, including one or more devices of these systems. For example, in-phase and quadrature-phase structure 400 may support correcting in-phase and quadrature-phase imbalances. The in-phase and quadrature-phase structure 400 may receive as input a signal 210-c, which may be an example of aspects of a signal as described herein. The signal 210-c, for example, may be a complex signal. As such, both rails in the in-phase and quadrature-phase structure 400 may process a complex signal (e.g., x), where a first rail process the complex signal and a second rail processes the conjugate 405 of the complex signal (e.g., x*).

In contrast to other in-phase and quadrature-phase correction structures, the in-phase and quadrature-phase structure 400 may be kernel-based, which may resolve the in-phase and quadrature-phase imbalance in a single shot. That is, the kernel-based analysis may use training signal pairs (the in-phase and quadrature-phase impairment system input and output) as analysis intakes. According to the kernel-based analysis, the in-phase and quadrature-phase structure 400 may be determined directly. Both the imbalance model and correction associated with the in-phase and quadrature-phase structure 400 may be composed of time domain kernel x and x* as described herein. Compared to the other IQ correction structure, the kernel-based in-phase and quadrature-phase structure 400 may be a more general filtering structure as shown in FIG. 4.

Returning to the in-phase and quadrature-phase structure 400, the input signal 210-c may be passed through a first rail that may output a real-valued component of the signal 210-c, and passed through a second rail that may output a complex-valued component of the signal 210-c. The first rail and the second rail may include a set of tone probing elements 410 to estimate in-phase and quadrature-phase imbalance of a channel at several frequency spots. Compared to the other in-phase and quadrature-phase correction structure, the kernel-based in-phase and quadrature-phase structure 400 may include multiple tone probing elements 410 in the first rail (e.g., the other in-phase and quadrature-phase structure correction has one tap direct signal path with unit value (e.g., m=1 and a1=1)).

The first and second rails of the in-phase and quadrature-phase structure 400 may also include a set of components that may store or be configured to act as weighted coefficients 415 (also referred to herein as weighting values). For example, each tone probing element 410 may at a certain frequency spot probe the signal 210-c or the conjugate of the signal 210-c. In some examples, some in-phase and quadrature-phase structures may aim at suppressing the in-phase and quadrature-phase image of each of the calibration tones that may lead to a residual signal dependent distortion. For example, considering legacy in-phase and quadrature-phase correction formatted according to the following expression:

y(t)=x(t)+IQC(t)⊗x*(t) (7)

and the in-phase and quadrature-phase imbalance modelled according to the following expression:

z(t)=y(t)+IQ(t)⊗y*(t) (8).

By cascading the in-phase and quadrature-phase correction with the in-phase and quadrature-phase imbalance system, the in-phase and quadrature-phase imbalance correction system output may be defined by the following expressions:

$$\begin{matrix}z ( t ) = y ( t ) + IQ ( t ) ⊗ {y}^{*} ( t ) & ( 9 ) \\ = x ( t ) + IQC ( t ) ⊗ {x}^{*} ( t ) + IQ ( t ) ⊗ {[ x ( t ) + IQC ( t ) ⊗ {x}^{*} ( t ) ]}^{*} & ( 10 ) \\ = x ( t ) + IQC ( t ) ⊗ {x}^{*} ( t ) + IQ ( t ) ⊗ [ {x}^{*} ( t ) + {IQC}^{*} ( t ) ⊗ x ( t ) ] & ( 11 ) \\ = x ( t ) ⊗ [ δ ( t ) + IQ ( t ) ⊗ {IQC}^{*} ( t ) ] + {x}^{*} ( t ) ⊗ [ IQC ( t ) ⊗ IQ ( t ) ] & ( 12 )\end{matrix}$$

As a result, in legacy the in-phase and quadrature-phase correction, the in-phase and quadrature-phase correction can be expressed in form of:

IQC(t)=−IQ(t) (13)

With this ideal in-phase and quadrature-phase correction, the system output is defined by the following expression:

z(t)=x(t)⊗[δ(t)−IQ(t)⊗IQ*(t)] (14)

Note that, for large in-phase and quadrature-phase imbalance, such legacy in-phase and quadrature-phase correction may result in a distortion of x(t)⊗IQ(t)⊗IQ*(t) from the original signal x(t).

The in-phase and quadrature-phase structure 400 may apply to each output of the tone probing element 410 (e.g., probed signal 210-c or probed conjugate of the signal 210-c) a weighted coefficient 415. The in-phase and quadrature-phase structure 400 may then sum the set of weighted probed signals. As a result, the in-phase and quadrature-phase structure 400 may output a signal 210-d, which may be a sum of a real-valued component of the signal 210-c and a complex-valued component of the signal 210-c. That is, the signal 210-d may be corrected for the in-phase and quadrature-phase imbalance of the signal 210-c. Therefore, compared to the other in-phase and quadrature-phase correction structure (for example, as shown in FIG. 3), the kernel-based in-phase and quadrature-phase structure 400 may be a more general filtering structure, which may resolve the in-phase and quadrature-phase imbalance in a single shot.

Accordingly, the in-phase and quadrature-phase structure 400 described herein may provide improvements in in-phase and quadrature-phase correction compared to other techniques. That is, other in-phase and quadrature-phase correction structures aim at suppressing the in-phase and quadrature-phase image, which may result in signal distortion measured using MSE. Compared to the other in-phase and quadrature-phase correction structures, the kernel-based in-phase and quadrature-phase structure 400 may be based on a direct inversion technique aiming at obtaining an exact original signal after the in-phase and quadrature-phase correction (e.g., with minimal time domain MSE). Furthermore, the in-phase and quadrature-phase structure 400 described herein may provide benefits and enhancements to the operation of communication devices. The in-phase and quadrature-phase structure 400 described herein may also provide efficiency to communication devices by reducing latency associated with processes related to correcting in-phase and quadrature-phase imbalances.

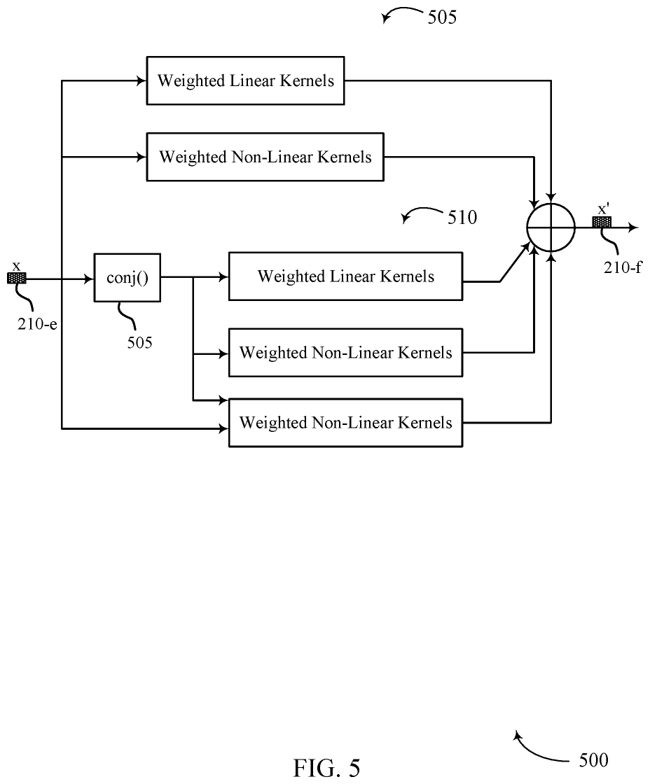

FIG. 5 illustrates an example of an in-phase and quadrature-phase structure 500 that supports in-phase and quadrature-phase estimation and correction using kernel analysis in accordance with aspects of the present disclosure. The in-phase and quadrature-phase structure 500 may also be referred to as in-phase and quadrature-phase imbalance correction structure 500. In some examples, the in-phase and quadrature-phase structure 500 may implement aspects of the wireless communications systems 100 and 200, including one or more devices of these systems. For example, in-phase and quadrature-phase structure 500 may support kernel-based in-phase and quadrature-phase imbalance for non-linear frequency dependent in-phase and quadrature-phase imbalance. The in-phase and quadrature-phase structure 500 may receive as input a signal 210-e, which may be an example of aspects of a signal as described herein. The signal 210-e, for example, may be a complex signal. As such, both rails in the in-phase and quadrature-phase structure 500 may process a complex signal (e.g., x), where a first rail process the complex signal and a second rail processes the conjugate 505 of the complex signal (e.g., x*).

Returning to the in-phase and quadrature-phase structure 500, the input signal 210-e may be passed through a first rail that may output a real-valued component of the signal 210-e, and passed through a second rail that may output a complex-valued component of the signal 210-e. The first rail and the second rail may include a set of weighted liner kernels and weighted non-linear kernels 505 and 510 to estimate in-phase and quadrature-phase imbalance of the signal 210-e. The in-phase and quadrature-phase structure 500 may illustrate an example where frequency dependent in-phase and quadrature-phase imbalance is both large and non-linear. The presence of non-linear kernels in both the direct and conjugate path plus another set of non-linear kernels that combine the x and x* may be additional enhancement that are shown compared to FIGS. 3 and 4, for example, which only had the linear kernel terms. The in-phase and quadrature-phase structure 500 may sum the set of weighted signals. As a result, the in-phase and quadrature-phase structure 500 may output a signal 210-f, which may be a sum of a real-valued component of the signal 210-e and a complex-valued component of the signal 210-e.

Accordingly, the in-phase and quadrature-phase structure 500 described herein may provide improvements in in-phase and quadrature-phase correction compared to other techniques. Furthermore, the in-phase and quadrature-phase structure 500 described herein may provide benefits and enhancements to the operation of communication devices in presence of high and non-linear frequency dependent in-phase and quadrature-phase imbalance. The in-phase and quadrature-phase structure 500 described herein may also provide efficiency to communication devices by reducing latency associated with processes related to correcting in-phase and quadrature-phase imbalances.

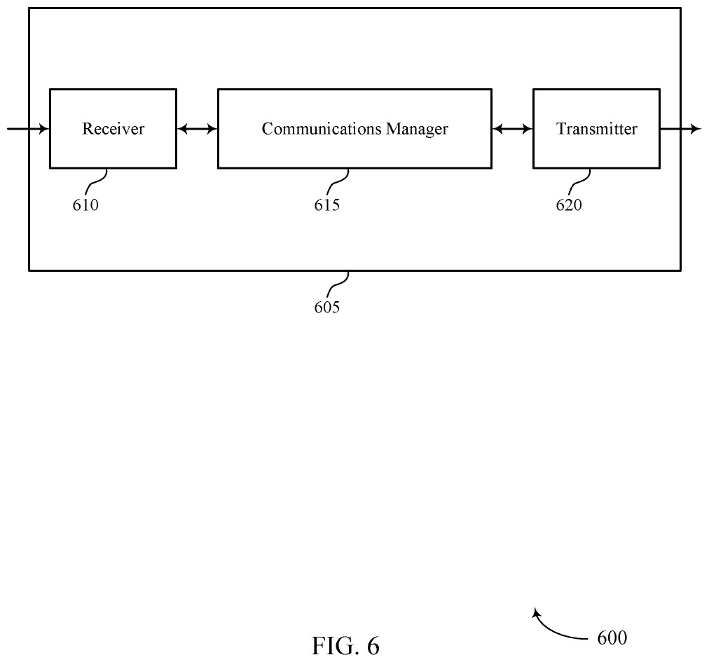

FIG. 6 shows a block diagram 600 of a device 605 that supports in-phase and quadrature-phase estimation and correction using kernel analysis in accordance with aspects of the present disclosure. The device 605 may be an example of aspects of a device as described herein. The device 605 may include a receiver 610, a communications manager 615, and a transmitter 620. The device 605 may also include a processor. Each of these components may be in communication with one another (e.g., via one or more buses).

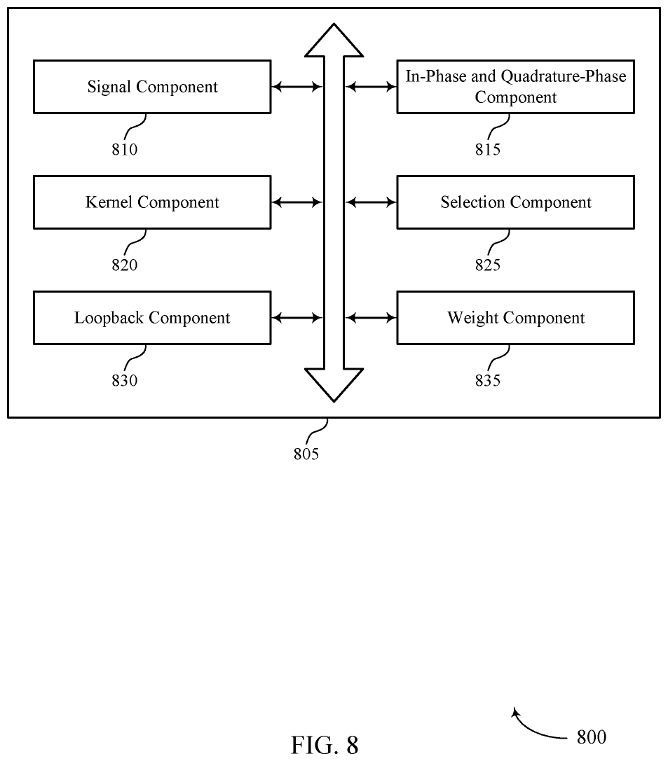

The receiver 610 may receive information such as packets, user data, or control information associated with various information channels (e.g., control channels, data channels, and information related to in-phase and quadrature-phase estimation and correction using kernel analysis, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may receive a signal, apply the in-phase and quadrature-phase imbalance correction term to the signal, determine an in-phase and quadrature-phase imbalance based on the signal, a phase and amplitude of the signal, a conjugate of the signal, or any combination thereof, determine, based on the in-phase and quadrature-phase imbalance, a kernel set having a set of in-phase and quadrature-phase imbalance correction terms, and select an in-phase and quadrature-phase imbalance correction term from the set of in-phase and quadrature-phase imbalance correction terms based on a selection criteria. The communications manager 615 may be an example of aspects of the communications manager 810 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 620 may transmit signals generated by other components of the device 605. In some examples, the transmitter 620 may be collocated with a receiver 610 in a transceiver module. For example, the transmitter 620 may be an example of aspects of the transceiver 820 described with reference to FIG. 8. The transmitter 620 may utilize a single antenna or a set of antennas.

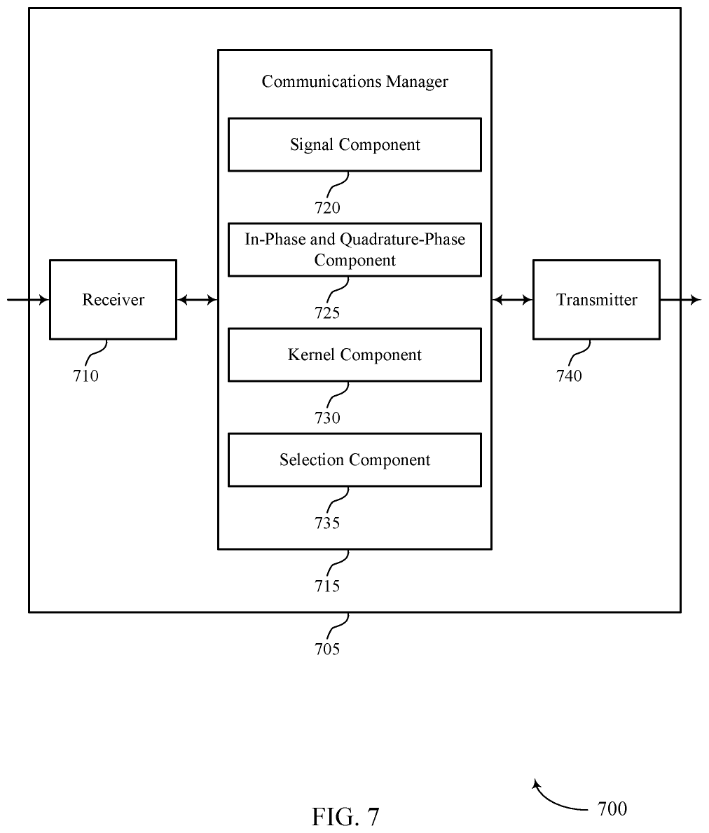

FIG. 7 shows a block diagram 700 of a device 705 that supports in-phase and quadrature-phase estimation and correction using kernel analysis in accordance with aspects of the present disclosure. The device 705 may be an example of aspects of a device 605 or a device 115 as described herein. The device 705 may include a receiver 710, a communications manager 715, and a transmitter 740. The device 705 may also include a processor. Each of these components may be in communication with one another (e.g., via one or more buses).

The receiver 710 may receive information such as packets, user data, or control information associated with various information channels (e.g., control channels, data channels, and information related to in-phase and quadrature-phase estimation and correction using kernel analysis, etc.). Information may be passed on to other components of the device 705. The receiver 710 may be an example of aspects of the transceiver 820 described with reference to FIG. 8. The receiver 710 may utilize a single antenna or a set of antennas.

The communications manager 715 may be an example of aspects of the communications manager 615 as described herein. The communications manager 715 may include a signal component 720, an in-phase and quadrature-phase component 725, a kernel component 730, and a selection component 735. The communications manager 715 may be an example of aspects of the communications manager 810 described herein.

The signal component 720 may receive a signal and apply an in-phase and quadrature-phase imbalance correction term to the signal. The in-phase and quadrature-phase component 725 may determine an in-phase and quadrature-phase imbalance based on the signal, a phase and amplitude of the signal, a conjugate of the signal, or any combination thereof. The kernel component 730 may determine, based on the in-phase and quadrature-phase imbalance, a kernel set having a set of in-phase and quadrature-phase imbalance correction terms. The selection component 735 may select the in-phase and quadrature-phase imbalance correction term from the set of in-phase and quadrature-phase imbalance correction terms based on a selection criteria.

The transmitter 740 may transmit signals generated by other components of the device 705. In some examples, the transmitter 740 may be collocated with a receiver 710 in a transceiver module. For example, the transmitter 740 may be an example of aspects of the transceiver 820 described with reference to FIG. 8. The transmitter 740 may utilize a single antenna or a set of antennas.

FIG. 8 shows a block diagram 800 of a communications manager 805 that supports in-phase and quadrature-phase estimation and correction using kernel analysis in accordance with aspects of the present disclosure. The communications manager 805 may be an example of aspects of a communications manager 615, a communications manager 715, or a communications manager 810 described herein. The communications manager 805 may include a signal component 810, an in-phase and quadrature-phase component 815, a kernel component 820, a selection component 825, a loopback component 830, and a weight component 835. Each of these modules may communicate, directly or indirectly, with one another (e.g., via one or more buses).

The signal component 810 may receive a signal. In some cases, the signal includes a wideband signal or a narrowband signal. In some examples, the signal component 810 may apply an in-phase and quadrature-phase imbalance correction term to the signal.

The in-phase and quadrature-phase component 815 may determine an in-phase and quadrature-phase imbalance based on the signal, a phase and amplitude of the signal, a conjugate of the signal, or any combination thereof. In some examples, the in-phase and quadrature-phase component 815 may configure an in-phase and quadrature-phase imbalance correction structure based on a kernel set, where inverting a weighting value of the in-phase and quadrature-phase imbalance correction term with the in-phase and quadrature-phase imbalance correction structure may be further based on the configuring.

The kernel component 820 may determine, based on the in-phase and quadrature-phase imbalance, the kernel set having a set of in-phase and quadrature-phase imbalance correction terms. In some cases, the set of in-phase and quadrature-phase imbalance correction terms includes higher order terms. In some cases, the kernel set includes a quantity of nonlinear kernels each having a corresponding set of in-phase and quadrature-phase imbalance correction terms. In some examples, the kernel component 820 may perform a kernel search based on an order of the signal, an order of the conjugate of the signal, or a delay spacing, or a combination thereof, where determining the kernel set having the set of in-phase and quadrature-phase imbalance correction terms may be based on the kernel search.

In some examples, the kernel component 820 may include a weighted in-phase and quadrature-phase imbalance correction term in the kernel set, where applying the in-phase and quadrature-phase imbalance correction term to the signal further includes applying the weighted in-phase and quadrature-phase imbalance correction term to the signal. In some examples, the kernel component 820 may include an inverted weighted in-phase and quadrature-phase imbalance correction term in the kernel set, where applying the in-phase and quadrature-phase imbalance correction term to the signal further includes applying the inverted weighted in-phase and quadrature-phase imbalance correction term to the signal. In some examples, the kernel component 820 may determine, based on discarding a second in-phase and quadrature-phase imbalance correction term from the kernel set, that the kernel set having the set of in-phase and quadrature-phase imbalance correction terms is below a threshold set of in-phase and quadrature-phase imbalance correction terms. In some examples, the kernel component 820 may include a weighted third in-phase and quadrature-phase imbalance correction term in the kernel set, where the kernel set may be further based on including the weighted third in-phase and quadrature-phase imbalance correction term in the kernel set.

The selection component 825 may select the in-phase and quadrature-phase imbalance correction term from the set of in-phase and quadrature-phase imbalance correction terms based on a selection criteria. In some cases, the selection criteria includes a normalized mean square error. The loopback component 830 may identify a loopback configuration related to transmission of the signal, or reception of the signal, or both, where performing the kernel search is further based on the loopback configuration.

The weight component 835 may determine a weighting value for the in-phase and quadrature-phase imbalance correction term of the set of in-phase and quadrature-phase imbalance correction terms based on the kernel search. In some examples, the weight component 835 may determine that the weighting value of the in-phase and quadrature-phase imbalance correction term satisfies the selection criteria, where selecting the in-phase and quadrature-phase imbalance correction term from the set of in-phase and quadrature-phase imbalance correction terms is based on determining that the weighting value of the in-phase and quadrature-phase imbalance correction term satisfies the selection criteria.

In some examples, the weight component 835 may apply the weighting value to the in-phase and quadrature-phase imbalance correction term. In some examples, the weight component 835 may invert the weighting value of the in-phase and quadrature-phase imbalance correction term with the in-phase and quadrature-phase imbalance correction structure based on the weighting value satisfying a threshold. In some examples, the weight component 835 may apply the inverted weighting value to the in-phase and quadrature-phase imbalance correction term.

In some examples, the weight component 835 may determine a weighting value for the second in-phase and quadrature-phase imbalance correction term of the set of in-phase and quadrature-phase imbalance correction terms based on the kernel search, where the second in-phase and quadrature-phase imbalance correction term is different from the in-phase and quadrature-phase imbalance correction term. In some examples, the weight component 835 may determine that the weighting value of the second in-phase and quadrature-phase imbalance correction term does not satisfy the selection criteria. In some examples, the weight component 835 may discard the second in-phase and quadrature-phase imbalance correction term from the kernel set, where determining the kernel set is further based on discarding the second in-phase and quadrature-phase imbalance correction term from the kernel set. The weighting value for the in-phase and quadrature-phase imbalance correction term or the second in-phase and quadrature-phase imbalance correction term, or both may include a phase imbalance and amplitude imbalance of the signal. In some examples, the phase imbalance and the amplitude imbalance of the signal may be at least one of a frequency independent in-phase and quadrature-phase imbalance or a frequency dependent in-phase and quadrature-phase imbalance.

In some examples, the weight component 835 may determine a weighting value for the third in-phase and quadrature-phase imbalance correction term from the set of in-phase and quadrature-phase imbalance correction terms based on the kernel search, where the third in-phase and quadrature-phase imbalance correction term is different from the in-phase and quadrature-phase imbalance correction term. In some examples, the weight component 835 may determine that the weighting value of the third in-phase and quadrature-phase imbalance correction term satisfies the selection criteria. In some examples, the weight component 835 may apply the weighting value to the third in-phase and quadrature-phase imbalance correction term. In some examples, the weight component 835 may compare the weighted in-phase and quadrature-phase imbalance correction term in the kernel set to the weighted third in-phase and quadrature-phase imbalance correction term in the kernel set, where selecting the in-phase and quadrature-phase imbalance correction term is further based on the comparing.

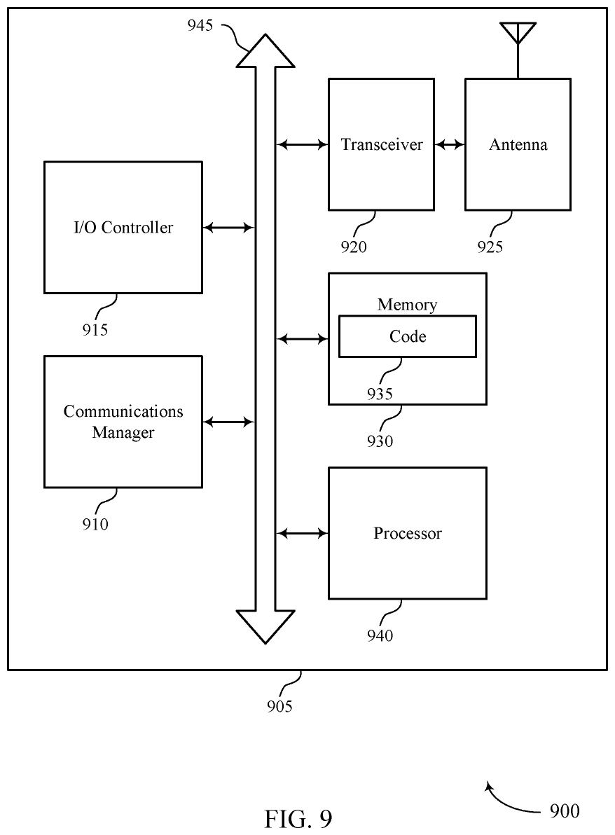

FIG. 9 shows a diagram of a system 900 including a device 905 that supports in-phase and quadrature-phase estimation and correction using kernel analysis in accordance with aspects of the present disclosure. The device 905 may be an example of or include the components of device 605, device 705, or a device as described herein. The device 905 may include components for bi-directional voice and data communications including components for transmitting and receiving communications, including a communications manager 910, an I/O controller 915, a transceiver 920, an antenna 925, memory 930, and a processor 940. These components may be in electronic communication via one or more buses (e.g., bus 945).

The communications manager 910 may receive a signal, apply the in-phase and quadrature-phase imbalance correction term to the signal, determine an in-phase and quadrature-phase imbalance based on the signal, a phase and amplitude of the signal, a conjugate of the signal, or any combination thereof, determine, based on the in-phase and quadrature-phase imbalance, a kernel set having a set of in-phase and quadrature-phase imbalance correction terms, and select an in-phase and quadrature-phase imbalance correction term from the set of in-phase and quadrature-phase imbalance correction terms based on a selection criteria.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS, ANDROID, MS-DOS, MS-WINDOWS, OS/2, UNIX, LINUX, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas. In some examples, the device 905 may include a single antenna 925. However, in some examples the device 905 may have more than one antenna 925, which may be capable of concurrently transmitting or receiving multiple wireless transmissions.

The memory 930 may include RAM and ROM. The memory 930 may store computer-readable, computer-executable code 935 including instructions that, when executed, cause the processor to perform various functions described herein. In some cases, the memory 930 may contain, among other things, a BIOS which may control basic hardware or software operation such as the interaction with peripheral components or devices.

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting in-phase and quadrature-phase estimation and correction using kernel analysis).

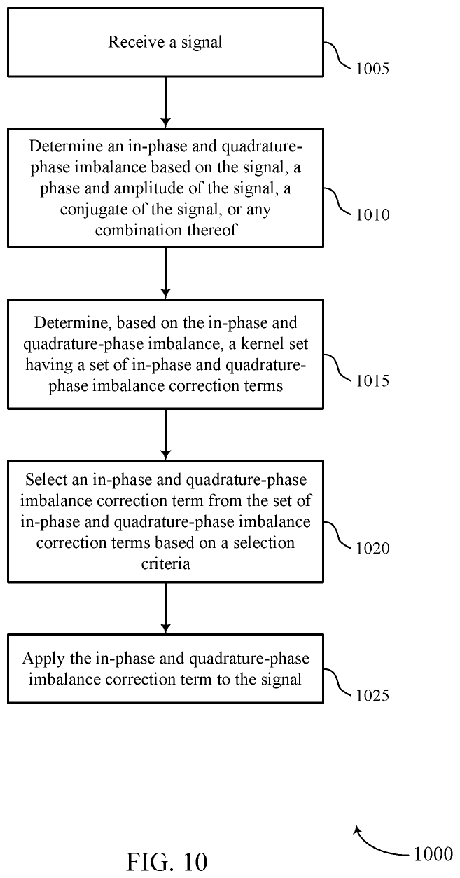

FIG. 10 shows a flowchart illustrating a method 1000 that supports in-phase and quadrature-phase estimation and correction using kernel analysis in accordance with aspects of the present disclosure. The operations of method 1000 may be implemented by a device or its components as described herein. For example, the operations of method 1000 may be performed by a communications manager as described with reference to FIGS. 6 through 9. In some examples, a device may execute a set of instructions to control the functional elements of the device to perform the functions described below. Additionally or alternatively, a device may perform aspects of the functions described below using special-purpose hardware.

At 1005, the device may receive a signal. The operations of 1005 may be performed according to the methods described herein. In some examples, aspects of the operations of 1005 may be performed by a signal component as described with reference to FIGS. 6 through 9.

At 1010, the device may determine an in-phase and quadrature-phase imbalance based on the signal, a phase and amplitude of the signal, a conjugate of the signal, or any combination thereof. The operations of 1010 may be performed according to the methods described herein. In some examples, aspects of the operations of 1010 may be performed by an in-phase and quadrature-phase component as described with reference to FIGS. 6 through 9.

At 1015, the device may determine, based on the in-phase and quadrature-phase imbalance, a kernel set having a set of in-phase and quadrature-phase imbalance correction terms. The operations of 1015 may be performed according to the methods described herein. In some examples, aspects of the operations of 1015 may be performed by a kernel component as described with reference to FIGS. 6 through 9.

At 1020, the device may select an in-phase and quadrature-phase imbalance correction term from the set of in-phase and quadrature-phase imbalance correction terms based on a selection criteria. In some examples, the device may select multiple in-phase and quadrature-phase imbalance correction terms from the set of in-phase and quadrature-phase imbalance correction terms. The operations of 1020 may be performed according to the methods described herein. In some examples, aspects of the operations of 1020 may be performed by a selection component as described with reference to FIGS. 6 through 9.

At 1025, the device may apply the in-phase and quadrature-phase imbalance correction term to the signal. In some examples, the device may combine or apply multiple selected in-phase and quadrature-phase imbalance correction terms from the set of in-phase and quadrature-phase imbalance correction terms to the signal. The operations of 1025 may be performed according to the methods described herein. In some examples, aspects of the operations of 1025 may be performed by a signal component as described with reference to FIGS. 6 through 9.

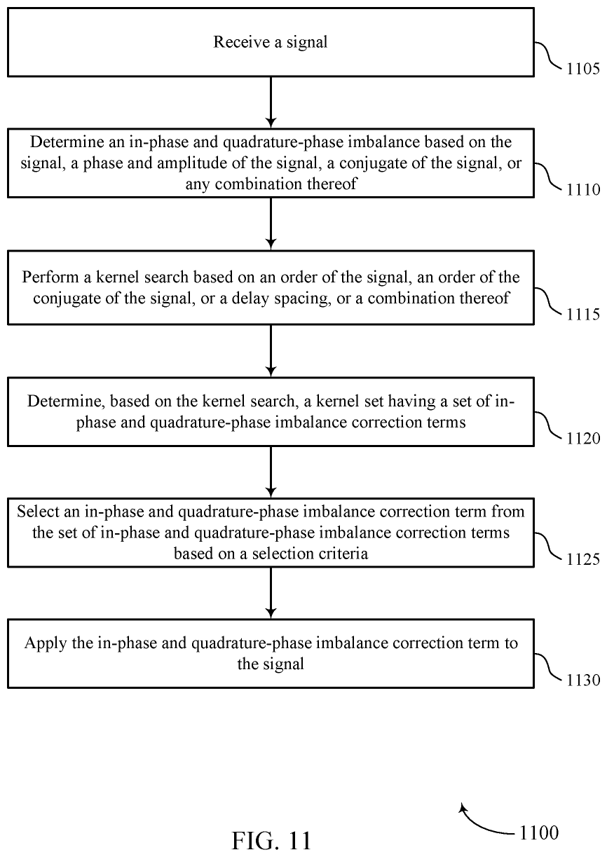

FIG. 11 shows a flowchart illustrating a method 1100 that supports in-phase and quadrature-phase estimation and correction using kernel analysis in accordance with aspects of the present disclosure. The operations of method 1100 may be implemented by a device or its components as described herein. For example, the operations of method 1100 may be performed by a communications manager as described with reference to FIGS. 6 through 9. In some examples, a device may execute a set of instructions to control the functional elements of the device to perform the functions described below. Additionally or alternatively, a device may perform aspects of the functions described below using special-purpose hardware.

At 1105, the device may receive a signal. The operations of 1105 may be performed according to the methods described herein. In some examples, aspects of the operations of 1105 may be performed by a signal component as described with reference to FIGS. 6 through 9.

At 1110, the device may determine an in-phase and quadrature-phase imbalance based on the signal, a phase and amplitude of the signal, a conjugate of the signal, or any combination thereof. The operations of 1110 may be performed according to the methods described herein. In some examples, aspects of the operations of 1110 may be performed by an in-phase and quadrature-phase component as described with reference to FIGS. 6 through 9.

At 1115, the device may perform a kernel search based on an order of the signal, an order of the conjugate of the signal, or a delay spacing, or a combination thereof. The operations of 1115 may be performed according to the methods described herein. In some examples, aspects of the operations of 1115 may be performed by a kernel component as described with reference to FIGS. 6 through 9.

At 1120, the device may determine, based on the kernel search, a kernel set having a set of in-phase and quadrature-phase imbalance correction terms. The operations of 1120 may be performed according to the methods described herein. In some examples, aspects of the operations of 1120 may be performed by a kernel component as described with reference to FIGS. 6 through 9.

At 1125, the device may select an in-phase and quadrature-phase imbalance correction term from the set of in-phase and quadrature-phase imbalance correction terms based on a selection criteria. In some examples, the device may select multiple in-phase and quadrature-phase imbalance correction terms from the set of in-phase and quadrature-phase imbalance correction terms. The operations of 1125 may be performed according to the methods described herein. In some examples, aspects of the operations of 1125 may be performed by a selection component as described with reference to FIGS. 6 through 9.

At 1130, the device may apply the in-phase and quadrature-phase imbalance correction term to the signal. In some examples, the device may combine or apply multiple selected in-phase and quadrature-phase imbalance correction terms from the set of in-phase and quadrature-phase imbalance correction terms to the signal. The operations of 1130 may be performed according to the methods described herein. In some examples, aspects of the operations of 1130 may be performed by a signal component as described with reference to FIGS. 6 through 9.

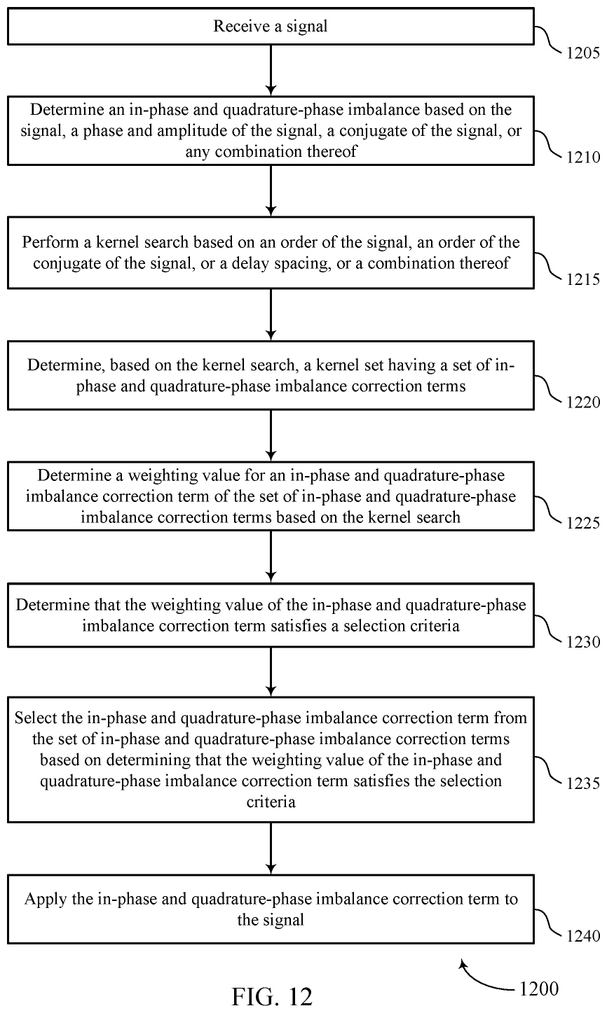

FIG. 12 shows a flowchart illustrating a method 1200 that supports in-phase and quadrature-phase estimation and correction using kernel analysis in accordance with aspects of the present disclosure. The operations of method 1200 may be implemented by a device or its components as described herein. For example, the operations of method 1200 may be performed by a communications manager as described with reference to FIGS. 6 through 9. In some examples, a device may execute a set of instructions to control the functional elements of the device to perform the functions described below. Additionally or alternatively, a device may perform aspects of the functions described below using special-purpose hardware.

At 1205, the device may receive a signal. The operations of 1205 may be performed according to the methods described herein. In some examples, aspects of the operations of 1205 may be performed by a signal component as described with reference to FIGS. 6 through 9.

At 1210, the device may determine an in-phase and quadrature-phase imbalance based on the signal, a phase and amplitude of the signal, a conjugate of the signal, or any combination thereof. The operations of 1210 may be performed according to the methods described herein. In some examples, aspects of the operations of 1210 may be performed by an in-phase and quadrature-phase component as described with reference to FIGS. 6 through 9.

At 1215, the device may perform a kernel search based on an order of the signal, an order of the conjugate of the signal, or a delay spacing, or a combination thereof. The operations of 1215 may be performed according to the methods described herein. In some examples, aspects of the operations of 1215 may be performed by a kernel component as described with reference to FIGS. 6 through 9.

At 1220, the device may determine, based on the kernel search, a kernel set having a set of in-phase and quadrature-phase imbalance correction terms. The operations of 1220 may be performed according to the methods described herein. In some examples, aspects of the operations of 1220 may be performed by a kernel component as described with reference to FIGS. 6 through 9.

At 1225, the device may determine a weighting value for an in-phase and quadrature-phase imbalance correction term of the set of in-phase and quadrature-phase imbalance correction terms based on the kernel search. The operations of 1225 may be performed according to the methods described herein. In some examples, aspects of the operations of 1225 may be performed by a weight component as described with reference to FIGS. 6 through 9.

At 1230, the device may determine that the weighting value of the in-phase and quadrature-phase imbalance correction term satisfies a selection criteria. The operations of 1230 may be performed according to the methods described herein. In some examples, aspects of the operations of 1230 may be performed by a weight component as described with reference to FIGS. 6 through 9.

At 1235, the device may select the in-phase and quadrature-phase imbalance correction term from the set of in-phase and quadrature-phase imbalance correction terms based on determining that the weighting value of the in-phase and quadrature-phase imbalance correction term satisfies the selection criteria. In some examples, the device may select multiple in-phase and quadrature-phase imbalance correction terms from the set of in-phase and quadrature-phase imbalance correction terms. The operations of 1235 may be performed according to the methods described herein. In some examples, aspects of the operations of 1235 may be performed by a selection component as described with reference to FIGS. 6 through 9.

At 1240, the device may apply the in-phase and quadrature-phase imbalance correction term to the signal. In some examples, the device may combine or apply multiple selected in-phase and quadrature-phase imbalance correction terms from the set of in-phase and quadrature-phase imbalance correction terms to the signal. The operations of 1240 may be performed according to the methods described herein. In some examples, aspects of the operations of 1240 may be performed by a signal component as described with reference to FIGS. 6 through 9.

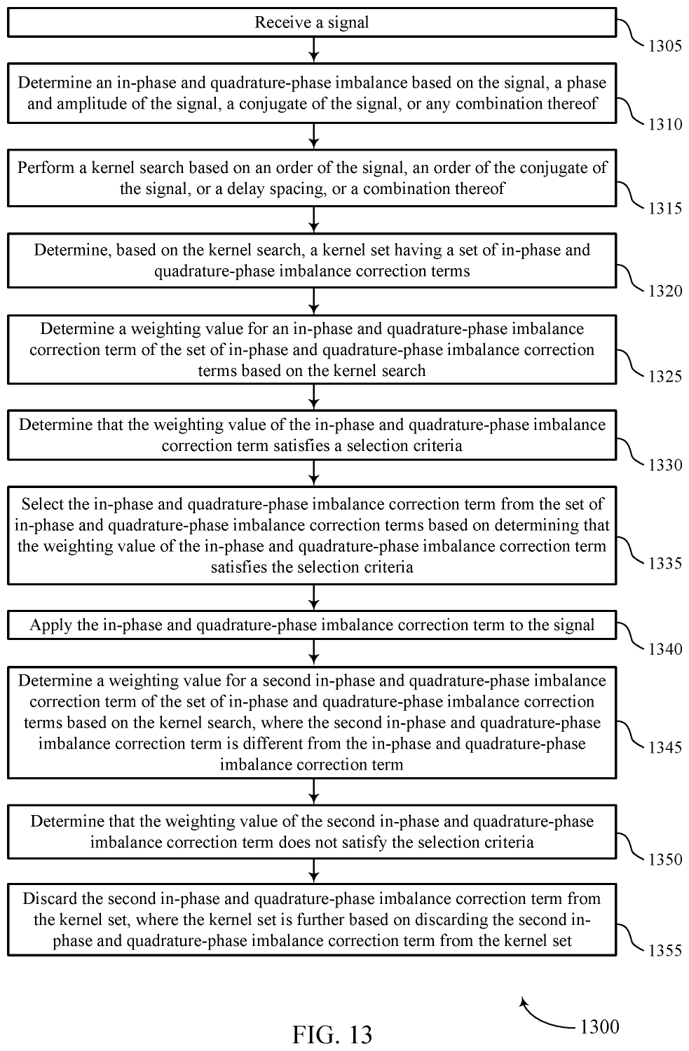

FIG. 13 shows a flowchart illustrating a method 1300 that supports in-phase and quadrature-phase estimation and correction using kernel analysis in accordance with aspects of the present disclosure. The operations of method 1300 may be implemented by a device or its components as described herein. For example, the operations of method 1300 may be performed by a communications manager as described with reference to FIGS. 6 through 9. In some examples, a device may execute a set of instructions to control the functional elements of the device to perform the functions described below. Additionally or alternatively, a device may perform aspects of the functions described below using special-purpose hardware.

At 1305, the device may receive a signal. The operations of 1305 may be performed according to the methods described herein. In some examples, aspects of the operations of 1305 may be performed by a signal component as described with reference to FIGS. 6 through 9.

At 1310, the device may determine an in-phase and quadrature-phase imbalance based on the signal, a phase and amplitude of the signal, a conjugate of the signal, or any combination thereof. The operations of 1310 may be performed according to the methods described herein. In some examples, aspects of the operations of 1310 may be performed by an in-phase and quadrature-phase component as described with reference to FIGS. 6 through 9.

At 1315, the device may perform a kernel search based on an order of the signal, an order of the conjugate of the signal, or a delay spacing, or a combination thereof. The operations of 1315 may be performed according to the methods described herein. In some examples, aspects of the operations of 1315 may be performed by a kernel component as described with reference to FIGS. 6 through 9.

At 1320, the device may determine, based on the kernel search, a kernel set having a set of in-phase and quadrature-phase imbalance correction terms. The operations of 1320 may be performed according to the methods described herein. In some examples, aspects of the operations of 1320 may be performed by a kernel component as described with reference to FIGS. 6 through 9.

At 1325, the device may determine a weighting value for an in-phase and quadrature-phase imbalance correction term of the set of in-phase and quadrature-phase imbalance correction terms based on the kernel search. The operations of 1325 may be performed according to the methods described herein. In some examples, aspects of the operations of 1325 may be performed by a weight component as described with reference to FIGS. 6 through 9.

At 1330, the device may determine that the weighting value of the in-phase and quadrature-phase imbalance correction term satisfies a selection criteria. The operations of 1330 may be performed according to the methods described herein. In some examples, aspects of the operations of 1330 may be performed by a weight component as described with reference to FIGS. 6 through 9.

At 1335, the device may select the in-phase and quadrature-phase imbalance correction term from the set of in-phase and quadrature-phase imbalance correction terms based on determining that the weighting value of the in-phase and quadrature-phase imbalance correction term satisfies the selection criteria. In some examples, the device may select multiple in-phase and quadrature-phase imbalance correction terms from the set of in-phase and quadrature-phase imbalance correction terms. The operations of 1335 may be performed according to the methods described herein. In some examples, aspects of the operations of 1335 may be performed by a selection component as described with reference to FIGS. 6 through 9.

At 1340, the device may apply the in-phase and quadrature-phase imbalance correction term to the signal. The operations of 1340 may be performed according to the methods described herein. In some examples, the device may combine or apply multiple selected in-phase and quadrature-phase imbalance correction terms from the set of in-phase and quadrature-phase imbalance correction terms to the signal. In some examples, aspects of the operations of 1340 may be performed by a signal component as described with reference to FIGS. 6 through 9.

At 1345, the device may determine a weighting value for a second in-phase and quadrature-phase imbalance correction term of the set of in-phase and quadrature-phase imbalance correction terms based on the kernel search, where the second in-phase and quadrature-phase imbalance correction term is different from the in-phase and quadrature-phase imbalance correction term. The operations of 1345 may be performed according to the methods described herein. In some examples, aspects of the operations of 1345 may be performed by a weight component as described with reference to FIGS. 6 through 9.

At 1350, the device may determine that the weighting value of the second in-phase and quadrature-phase imbalance correction term does not satisfy the selection criteria. The operations of 1350 may be performed according to the methods described herein. In some examples, aspects of the operations of 1350 may be performed by a weight component as described with reference to FIGS. 6 through 9.

At 1355, the device may discard the second in-phase and quadrature-phase imbalance correction term from the kernel set, where the kernel set is further based on discarding the second in-phase and quadrature-phase imbalance correction term from the kernel set. The operations of 1355 may be performed according to the methods described herein. In some examples, aspects of the operations of 1355 may be performed by a weight component as described with reference to FIGS. 6 through 9.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications, comprising:
receiving a signal;
determining an in-phase and quadrature-phase imbalance based at least in part on the signal, a phase and amplitude of the signal, a conjugate of the signal, or any combination thereof;
determining, based at least in part on the in-phase and quadrature-phase imbalance, a kernel set having a set of in-phase and quadrature-phase imbalance correction terms;
determining a weighting value for an in-phase and quadrature-phase imbalance correction term of the set of in-phase and quadrature-phase imbalance correction terms based at least in part on a kernel search;
selecting the in-phase and quadrature-phase imbalance correction term from the set of in-phase and quadrature-phase imbalance correction terms based at least in part on determining that the weighting value of the in-phase and quadrature-phase imbalance correction term satisfies a selection criteria;
applying the weighting value to the in-phase and quadrature-phase imbalance correction term; and
applying the in-phase and quadrature-phase imbalance correction term to the signal.

2. The method of claim 1, further comprising:
performing the kernel search based at least in part on an order of the signal, an order of the conjugate of the signal, or a delay spacing, or a combination thereof, wherein determining the kernel set having the set of in-phase and quadrature-phase imbalance correction terms is based at least in part on the kernel search.

3. The method of claim 2, further comprising:
identifying a loopback configuration related to transmission of the signal, or reception of the signal, or both, wherein performing the kernel search is further based at least in part on the loopback configuration.

4. (canceled)

5. The method of claim 1, further comprising:
including the weighted in-phase and quadrature-phase imbalance correction term in the kernel set.

6. The method of claim 1, further comprising:
inverting the weighting value of the in-phase and quadrature-phase imbalance correction term with an in-phase and quadrature-phase imbalance correction structure based at least in part on the weighting value satisfying a threshold;
applying the inverted weighting value to the in-phase and quadrature-phase imbalance correction term; and
including the inverted weighted in-phase and quadrature-phase imbalance correction term in the kernel set, wherein applying the in-phase and quadrature-phase imbalance correction term to the signal further comprises applying the inverted weighted in-phase and quadrature-phase imbalance correction term to the signal.

7. The method of claim 6, further comprising:
configuring the in-phase and quadrature-phase imbalance correction structure based at least in part on the kernel set, wherein inverting the weighting value of the in-phase and quadrature-phase imbalance correction term with the in-phase and quadrature-phase imbalance correction structure is further based at least in part on the configuring.

8. The method of claim 1, further comprising:
determining a weighting value for a second in-phase and quadrature-phase imbalance correction term of the set of in-phase and quadrature-phase imbalance correction terms based at least in part on the kernel search, wherein the second in-phase and quadrature-phase imbalance correction term is different from the in-phase and quadrature-phase imbalance correction term;
determining that the weighting value of the second in-phase and quadrature-phase imbalance correction term does not satisfy the selection criteria; and
discarding the second in-phase and quadrature-phase imbalance correction term from the kernel set, wherein determining the kernel set is further based at least in part on discarding the second in-phase and quadrature-phase imbalance correction term from the kernel set.

9. The method of claim 8, wherein the weighting value for the in-phase and quadrature-phase imbalance correction term or the second in-phase and quadrature-phase imbalance correction term, or both comprises a phase imbalance and amplitude imbalance of the signal.

10. The method of claim 9, wherein the phase imbalance and the amplitude imbalance of the signal is at least one of a frequency independent in-phase and quadrature-phase imbalance or a frequency dependent in-phase and quadrature-phase imbalance.

11. The method of claim 8, further comprising:
determining, based at least in part on discarding the second in-phase and quadrature-phase imbalance correction term from the kernel set, that the kernel set having the set of in-phase and quadrature-phase imbalance correction terms is below a threshold set of in-phase and quadrature-phase imbalance correction terms;
determining a weighting value for a third in-phase and quadrature-phase imbalance correction term from the set of in-phase and quadrature-phase imbalance correction terms based at least in part on the kernel search, wherein the third in-phase and quadrature-phase imbalance correction term is different from the in-phase and quadrature-phase imbalance correction term;
determining that the weighting value of the third in-phase and quadrature-phase imbalance correction term satisfies the selection criteria;
applying the weighting value to the third in-phase and quadrature-phase imbalance correction term; and
including the weighted third in-phase and quadrature-phase imbalance correction term in the kernel set, wherein the kernel set is further based at least in part on including the weighted third in-phase and quadrature-phase imbalance correction term in the kernel set.

12. The method of claim 11, further comprising:
comparing the weighted in-phase and quadrature-phase imbalance correction term in the kernel set to the weighted third in-phase and quadrature-phase imbalance correction term in the kernel set, wherein selecting the in-phase and quadrature-phase imbalance correction term is further based at least in part on the comparing.

13. The method of claim 1, wherein the set of in-phase and quadrature-phase imbalance correction terms comprises higher order terms.

14. The method of claim 1, wherein the kernel set comprises a quantity of nonlinear kernels each having a corresponding set of in-phase and quadrature-phase imbalance correction terms.

15. The method of claim 1, wherein:
the signal comprises a wideband signal or a narrowband signal; and
the selection criteria comprises a normalized mean square error.

16. An apparatus for wireless communications, comprising:
a processor,
memory in electronic communication with the processor; and
instructions stored in the memory and executable by the processor to cause the apparatus to:
receive a signal;
determine an in-phase and quadrature-phase imbalance based at least in part on the signal, a phase and amplitude of the signal, a conjugate of the signal, or any combination thereof;
determine, based at least in part on the in-phase and quadrature-phase imbalance, a kernel set having a set of in-phase and quadrature-phase imbalance correction terms;
determine a weighting value for an in-phase and quadrature-phase imbalance correction term of the set of in-phase and quadrature-phase imbalance correction terms based at least in part on a kernel search;
select the in-phase and quadrature-phase imbalance correction term from the set of in-phase and quadrature-phase imbalance correction terms based at least in part on determining that the weighting value of the in-phase and quadrature-phase imbalance correction term satisfies a selection criteria;
apply the weighting value to the in-phase and quadrature-phase imbalance correction term; and
apply the in-phase and quadrature-phase imbalance correction term to the signal.

17. The apparatus of claim 16, wherein the instructions are further executable by the processor to cause the apparatus to:
perform the kernel search based at least in part on an order of the signal, an order of the conjugate of the signal, or a delay spacing, or a combination thereof, wherein determining the kernel set having the set of in-phase and quadrature-phase imbalance correction terms is based at least in part on the kernel search.

18. The apparatus of claim 17, wherein the instructions are further executable by the processor to cause the apparatus to:
identify a loopback configuration related to transmission of the signal, or reception of the signal, or both, wherein performing the kernel search is further based at least in part on the loopback configuration.

19. An apparatus for wireless communications, comprising:
means for receiving a signal;
means for determining an in-phase and quadrature-phase imbalance based at least in part on the signal, a phase and amplitude of the signal, a conjugate of the signal, or any combination thereof;
means for determining, based at least in part on the in-phase and quadrature-phase imbalance, a kernel set having a set of in-phase and quadrature-phase imbalance correction terms;
means for determining a weighting value for an in-phase and quadrature-phase imbalance correction term of the set of in-phase and quadrature-phase imbalance correction terms based at least in part on a kernel search;
means for selecting the in-phase and quadrature-phase imbalance correction term from the set of in-phase and quadrature-phase imbalance correction terms based at least in part on determining that the weighting value of the in-phase and quadrature-phase imbalance correction term satisfies a selection criteria;
means for applying the weighting value to the in-phase and quadrature-phase imbalance correction term; and
means for applying the in-phase and quadrature-phase imbalance correction term to the signal.

20. The apparatus of claim 19, further comprising:
means for performing the kernel search based at least in part on an order of the signal, an order of the conjugate of the signal, or a delay spacing, or a combination thereof, wherein determining the kernel set having the set of in-phase and quadrature-phase imbalance correction terms is based at least in part on the kernel search.
